(19) United States
(12) Patent Application Publication
(10) Pub. No.: US 2013/0346723 A1
(43) Pub. Date: Dec. 26, 2013

(54) METHOD AND APPARATUS TO PROTECT DATA INTEGRITY

(71) Applicant: Shunji KAWAMURA, Yokohama-shi (JP)

(72) Inventor: Shunji KAWAMURA, Yokohama-shi (JP)

(73) Assignee: HITACHI, LTD., Tokyo (JP)

(21) Appl. No.: 13/530,720

(22) Filed: Jun. 22, 2012

(51) Int. Cl. G06F 12/02

(52) U.S. Cl. 711/170; 711/E12.002

(57) ABSTRACT

Exemplary embodiments of the invention protect data integrity stored in storage systems. In one embodiment, a storage system comprises: a plurality of storage devices; and a controller being operable to manage a plurality of logical volumes and an attribute of each of the plurality of logical volumes, the plurality of logical volumes including a first logical volume which is mapped to at least a portion of the plurality of storage devices and a second logical volume which is mapped to another storage system. The attribute of the second logical volume indicates whether or not said another storage system can support to store data including protection information added by a server. The controller is operable to send in reply the data including the protection information, in accordance with a read request from the server, by managing the protection information and the attribute of the second logical volume.

### BACKGROUND OF THE INVENTION

The present invention relates generally to storage systems and, more particularly, to methods and apparatus to protect data integrity stored in storage systems.

Most disk drives use 512 byte sectors. Each sector is protected by a proprietary ECC (Error Correcting Code) internal to the drive firmware. The operating systems (OSs) deal in units of 512 bytes. Enterprise drives support 520/528 byte sectors. Storage systems use extra 8/16 bytes to protect data integrity inside them. Protection information (PI) such as Data Integrity Field (DIF) or Data Integrity Extensions (DIX) is used to protect data integrity. DIF protects integrity between the HBA (Host Bus Adaptor) and storage device. DIX protects integrity between the application/OS and HBA. DIX+DIF protects integrity between the application/OS and storage device. As used herein, the read/write commands to protect data integrity between initiator and target (host server and storage system) such as DIF or DIX+DIF are called “DI I/O” or data integrity input/output. External storage volume virtualization technology allows the use of other (external) storage systems' volumes in a way similar to internal physical drives (e.g., read and write I/O as internal physical drives).

### BRIEF SUMMARY OF THE INVENTION

Exemplary embodiments of the invention protect data integrity stored in storage systems. The data that is transferred between the storage system and DI (data integrity) I/O incapable external storage are without PI (protection information). If the logical device is physically stored in a DI I/O incapable external storage system, PI added by application/OS/HBA will be lost. According to specific embodiments of this invention, a DI I/O capable storage system can virtualize both DI I/O capable and incapable external storage systems. The DI I/O capable storage system allocates internal physical drives that have PI area, DI I/O capable external storage volumes, or additional PI area to PI I/O capable logical devices to keep PI. In this way, it is possible to support DIF in the external storage virtualization environment. It is cost effective to use low cost but DIF incapable storage systems as external storage systems. This invention also makes it easier to manage DIF/non-DIF coexisting environment. The invention can be used for protecting data integrity between host server and storage device in the external storage virtualization. The invention can be used without internal drives (all virtualized external storage). The invention can also be used without external storage system (only internal drives). This invention can also be used for protecting data integrity between host server and storage device in the data reduction storage virtualization such as thin-provisioning, data compression, data deduplication, or discarding particular data pattern.

In accordance with an aspect of the present invention, a storage system comprises: a plurality of storage devices; and a controller being operable to manage a plurality of logical volumes and an attribute of each of the plurality of logical volumes, the plurality of logical volumes including a first logical volume which is mapped to at least a portion of the plurality of storage devices and a second logical volume which is mapped to another storage system. The attribute of the second logical volume indicates whether or not said another storage system can support to store data including protection information added by a server. The controller is operable to send in reply the data including the protection information, in accordance with a read request from the server, by managing the protection information and the attribute of the second logical volume.

In some embodiments, the controller is configured to store the data including the protection information in the first logical volume if the attribute of the second logical volume indicates that said another storage system cannot support to store the data including the protection information. The controller is configured to store the data including the protection information in the second logical volume if the attribute of the second logical volume indicates that said another storage system can support to store the data including the protection information. The storage system further comprises a data integrity capable storage pool and a data integrity incapable storage pool. The controller is configured to perform thin provisioning allocation, from the data integrity capable storage pool or the data integrity incapable storage pool, based on the attributes of the logical volumes. The data integrity capable storage pool is used in the thin provisioning allocation for storing the data including the protection information, and the data integrity incapable storage pool is not used in the thin provisioning allocation for storing the data with the protection information.

In specific embodiments, the controller is configured to use said another storage system to store the protection information, if the attribute of the second logical volume indicates that said another storage system cannot support to store the data including the protection information. The controller is configured to store the protection information in a logical volume which is separate from another logical volume for storing a remaining portion of the data without the protection information. The controller is configured to combine the separately stored remaining portion of the data and protection information, in order to send in reply the data including the protection information, in accordance with the read request from the server. For a plurality of data each including a protection information added by the server, the controller is operable to reconfigure a larger size storage pool chunk in a storage pool to be larger in size than a chunk for storing only a remaining portion of the data without the protection information added by the server, in order to store both the protection information and the remaining portion of the data without the protection information in the same storage pool chunk.

In accordance with another aspect of the invention, a system comprises: a plurality of storage systems including a first storage system and a second storage system. The first storage system includes a plurality of storage devices and a controller, the controller being operable to manage a plurality of logical volumes and an attribute of each of the plurality of logical volumes, the plurality of logical volumes including a first logical volume which is mapped to at least a portion of the plurality of storage devices and a second logical volume which is mapped to the second storage system. The attribute of the second logical volume indicates whether or not the second storage system can support to store data including protection information added by a server. The controller is operable to send in reply the data including the protection information, in accordance with a read request from the server, by managing the protection information and the attribute of the second logical volume.

In some embodiments, the controller is configured to store the data including the protection information in the first logical volume if the attribute of the second logical volume indicates that the second storage system cannot support to store the data including the protection information. The controller is configured to store the data including the protection information in the second logical volume if the attribute of the second logical volume indicates that the second storage system can support to store the data including the protection information. The controller is configured to use the second storage system to store the protection information, if the attribute of the second logical volume indicates that the second storage system cannot support to store the data including the protection information.

Another aspect of this invention is directed to a computer-readable storage medium storing a plurality of instructions for controlling a data processor to manage a storage system which includes a plurality of storage devices. The plurality of instructions comprise: instructions that cause the data processor to manage a plurality of logical volumes and an attribute of each of the plurality of logical volumes, the plurality of logical volumes including a first logical volume which is mapped to at least a portion of the plurality of storage devices and a second logical volume which is mapped to another storage system, wherein the attribute of the second logical volume indicates whether or not said another storage system can support to store data including protection information added by a server; and instructions that cause the data processor to send in reply the data including the protection information, in accordance with a read request from the server, by managing the protection information and the attribute of the second logical volume.

These and other features and advantages of the present invention will become apparent to those of ordinary skill in the art in view of the following detailed description of the specific embodiments.

### BRIEF DESCRIPTION OF THE DRAWINGS

FIG. 1 is a system block diagram illustrating an outline of data integrity protection according to the first embodiment.

FIG. 2 illustrates an example of a physical system configuration of a system in which the method and apparatus of the invention may be applied according to the first embodiment.

FIG. 3 shows an example of the logical system configuration of the system in FIG. 2.

FIG. 4 shows an example of the contents of the shared memory of the storage system of FIG. 2.

FIG. 5a shows the DI type information of LDEV in a table.

FIG. 5b shows a mapping table of LU to LDEV.

FIG. 5c shows a mapping table of LDEV to storage pool.

FIG. 5d shows Information of EXDEV in a table.

FIG. 5e shows a mapping table of pool chunk to tier.

FIG. 5f shows information of RAID groups in a table.

FIG. 5g shows information of physical devices in a table.

FIG. 5h shows information of pool tier in a table.

FIG. 5i shows a mapping table of tier chunk to EXDEV/RAID group.

FIG. 5j shows information of free chunk in a diagram.

FIG. 5k shows cache directory management information in a table.

FIG. 5l shows clean queue LRU management information in a diagram.

FIG. 5m shows free queue management information in a diagram.

FIG. 5n shows sector information in a table.

FIG. 5o shows information of pool chunk usage in a table.

FIG. 6 is a flow diagram illustrating an example of LDEV creation according to the first embodiment.

FIG. 7 is a flow diagram illustrating an example of adding EXDEV.

FIG. 8 is a flow diagram illustrating an example of adding EXDEV to storage pool according to the first embodiment.

FIG. 9 is a flow diagram illustrating an example of a read I/O process.

FIG. 10 is a flow diagram illustrating a DI read I/O process.

FIG. 11 is a flow diagram illustrating an example of the staging process.

FIG. 12 is a flow diagram illustrating an example of a normal read I/O process.

FIG. 13 is a flow diagram illustrating an example of a write I/O process.

FIG. 14 is a flow diagram illustrating an example of a DI write I/O process.

FIG. 15 is a flow diagram illustrating an example of the destaging process.

FIG. 16 is a flow diagram illustrating an example of a normal write I/O process.

FIG. 17 is a system block diagram illustrating an outline of data integrity protection according to the second embodiment.

FIG. 18 show an example of DI type information of storage pool according to the second embodiment.

FIG. 19 is a flow diagram illustrating an example of adding EXDEV to storage pool according to the second embodiment.

FIG. 20 is a flow diagram illustrating an example of LDEV creation according to the second embodiment.

FIG. 21 is a system block diagram illustrating an outline of data integrity protection according to the third embodiment.

FIG. 22 is a diagram illustrating LDEV block to pool block mapping according to the third embodiment.

FIG. 23 is a diagram illustrating an outline of placing userdata and PI according to the third embodiment.

FIG. 24a shows an example of mapping between LDEV and pool.

FIG. 24b shows an example of mapping between pool chunk for PI to LDEV chunk for userdata.

FIG. 24c shows an example of mapping between LDEV chunk and pool chunk for PI.

FIG. 24d shows an example of pointer from LDEV ID to using chunk for PI.

FIG. 25 is a flow diagram illustrating an example of a write I/O process according to the third embodiment.

FIG. 26 is a flow diagram illustrating an example of a read I/O process according to the third embodiment.

FIG. 27 is a diagram illustrating LDEV block to pool block mapping according to the fourth embodiment.

FIG. 28 is a system block diagram illustrating an outline of data integrity protection according to the fifth embodiment.

FIG. 29 is a diagram illustrating LDEV block to pool block mapping according to the fifth embodiment.

FIG. 30 is a system block diagram illustrating an outline of data integrity protection according to the sixth embodiment.

FIG. 31 is a diagram illustrating LDEV block to pool block mapping according to the sixth embodiment.

FIG. 32 is a diagram illustrating an outline of placing userdata and PI according to the sixth embodiment.

FIG. 33 is a flow diagram illustrating an example of a write I/O process according to the sixth embodiment.

FIG. 34 is a flow diagram illustrating an example of a read I/O process according to the sixth embodiment.

FIG. 35 is a system block diagram illustrating an outline of data integrity protection according to the seventh embodiment.

FIG. 36 shows an example of information of DI TYPE STATE.

FIG. 37 is a flow diagram illustrating an example of DI type migration process according to the seventh embodiment.

FIG. 38 is a flow diagram illustrating an example of DI write I/O process during DI type migration according to the seventh embodiment.

FIG. 39 shows variations of stacks on the host server according to the ninth embodiment.

FIG. 39a shows a physical server case.

FIG. 39b shows an example of LPAR (Logical PARtitioned) virtual server.

FIG. 39c shows a virtual server hypervisor which provides storage as DAS to virtual machine.

FIG. 39d shows an example of a virtual server, where a hypervisor provides raw device mapping to virtual machine.

FIG. 39e shows an example of a virtual server, where a hypervisor provides file system to virtual machine.

FIG. 40 is a system block diagram illustrating an outline of data integrity protection according to the ninth embodiment.

FIG. 41 is a flow diagram illustrating an example of a write I/O process according to the ninth embodiment.

FIG. 42 is a flow diagram illustrating an example of a read I/O process according to the ninth embodiment.

FIG. 43 shows an example of the format of DIF.

FIG. 44 shows variations of diagrams illustrating LDEV block to pool block mapping with data reduction technology according to the eighth embodiment.

FIG. 44a is an example of diagram illustrating LDEV block to pool block mapping with compression technology.

FIG. 44b shows an example of diagram illustrating LDEV block to pool block mapping with deduplication technology.

FIG. 44c shows an example of diagram illustrating LDEV block to pool block mapping with discarding particular data pattern technology.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for protecting data integrity stored in storage systems. The following abbreviations are used throughout in this disclosure: DI (Data Integrity), PI (Protection Information), DIF (Data Integrity Field), DIX (Data Integrity Extension), GRD (guard tag), REF (reference tag), and APP (application tag).

First Embodiment

System Configuration

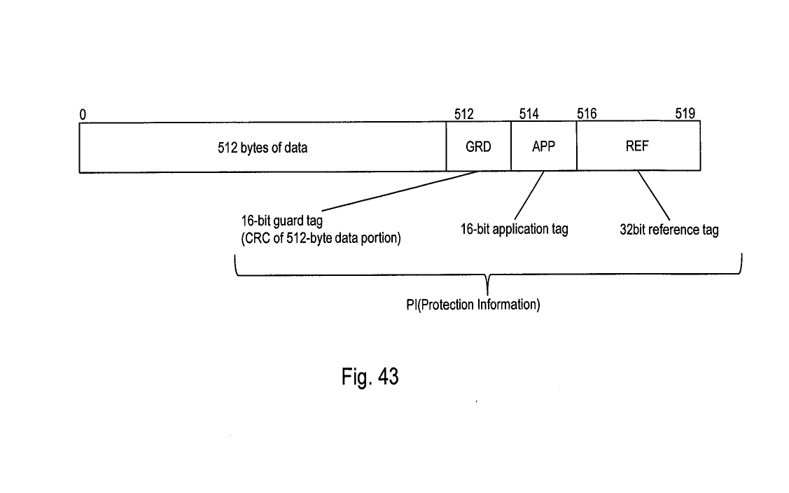

FIG. 43 shows an example of the format of DIF (Data Integrity Field). It includes GRD (Guard tag) which is a 16-bit CRC (Cyclic Redundancy Check) of the sector data, APP (Application tag) which is a 16-bit value that can be used by the operating system/application, and REF (Reference tag) which is a 32-bit number that is used to ensure the individual sectors are written in the right order, and in some cases, to the right physical sector. There can be some types of DIF to define the reference tag. See, e.g., Martin K. Petersen, Linux Data Integrity Extension, Proceedings of the Linux Symposium, Jul. 23-26, 2008, Ottawa, Ontario, Canada, pages 151-156, at section 2.1 (http://oss.oracle.com/˜mkp/docs/ols2008-petersen.pdf). As used herein, Type 0 also means DI I/O incapable, Types 1, 2, 3 also mean DI I/O capable. In a specific example, Type 0 means non protected; Type 1 means REF matches lower 32 bits of the target sector number; Type 2 means REF matches the seed value in the SCSI command+offset from beginning of I/O, and Type 3 means REF is undefined.

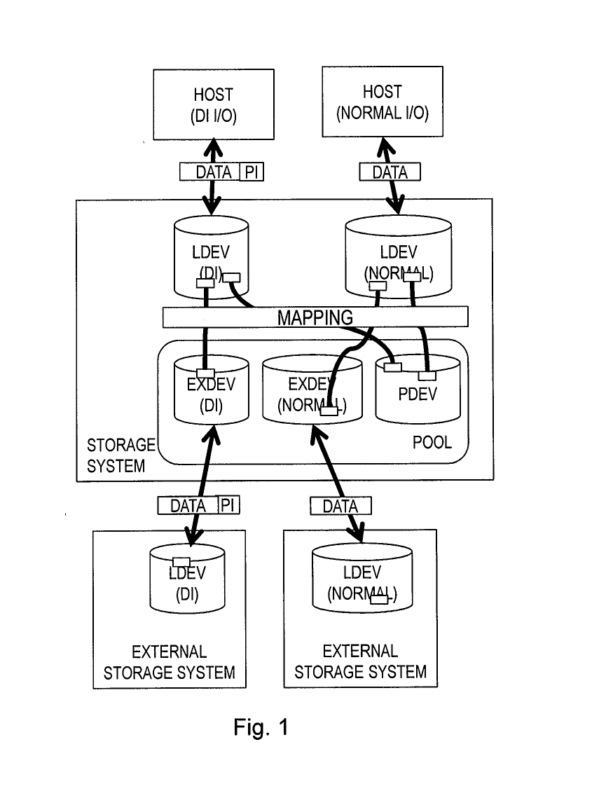

FIG. 1 is a system block diagram illustrating an outline of data integrity protection according to the first embodiment. FIG. 1 shows both a host server that uses DI I/O and a host server that does not. The storage system virtualizes external storage volumes. The external volumes include both DI I/O capable and DI I/O incapable ones (EXDEV(DI) & EXDEV(NODI)). The storage pool includes internal drives, EXDEV(DI), and EXDEV(NODI). The storage system use DI I/O with DI I/O capable external storage systems. The storage system provides DI I/O capable logical volumes (LDEV(DI)) and DI I/O incapable ones (LDEV(NODI)) to host servers. The storage system allocates internal drives or DI I/O capable external volumes to LDEV(DI) and does not allocate DI I/O incapable external volumes. The storage system can allocate DI I/O incapable external volumes to LDEV(NODI).

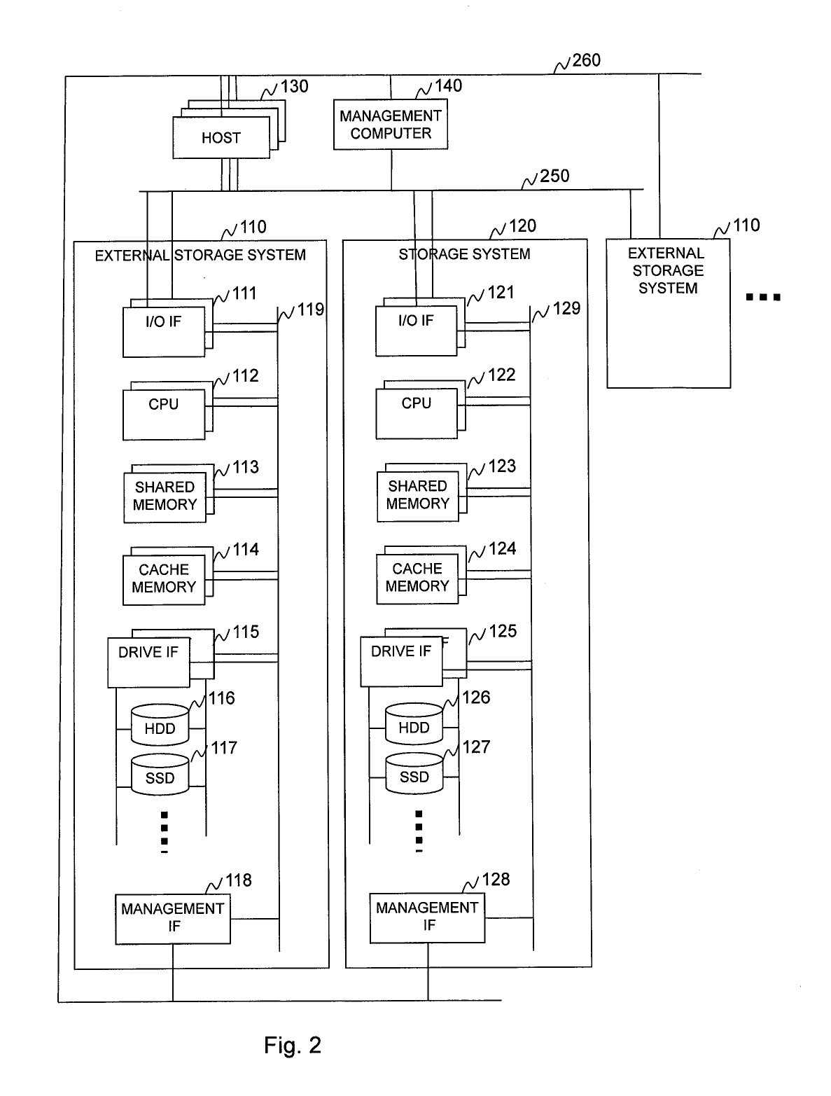

FIG. 2 illustrates an example of a physical system configuration of a system in which the method and apparatus of the invention may be applied according to the first embodiment. A storage area network (SAN) 250 is used as a data transfer network for the hosts 130, management computer 140, storage system 120, and external storage systems 110. A local area network (LAN) 260 is used as a management network. The storage system 120 includes an I/O interface (IF) 121, an CPU 122, a shared memory 123, a cache memory 124, a drive IF 125 for HDD (hard disk drive) 126 and SSD (solid state drive) 127, and a management IF 128, which are connected via a bus 129. There may be several types of HDDs 126 including, for example FC/SAS/SATA and having different capacity, different rpm, etc. The I/O interface 121 is used to communicate with the host 130. The I/O interface 121 is also used to communicate with (read from/write to) the external storage systems 110. It receives both DI/non-DI host I/O commands. It can send DI/non-DI I/O commands to the external storage system 110. The shared memory 123 stores programs and information tables. The storage systems 120 can be without internal physical drives. It may simply be an external storage volume virtualization appliance.

The external storage system 110 provides external volumes to the storage system 120. It is typically the same as the storage system 120. As seen in FIG. 2, the external storage system 110 includes an I/O interface 111, a CPU 112, a shared memory 113, a cache memory 114, a drive IF 115 for HDD 116 and SSD 117, and a management IF 118, which are connected via a bus 119. The management computer 140 also has network interface, CPU, memory, and programs inside the memory.

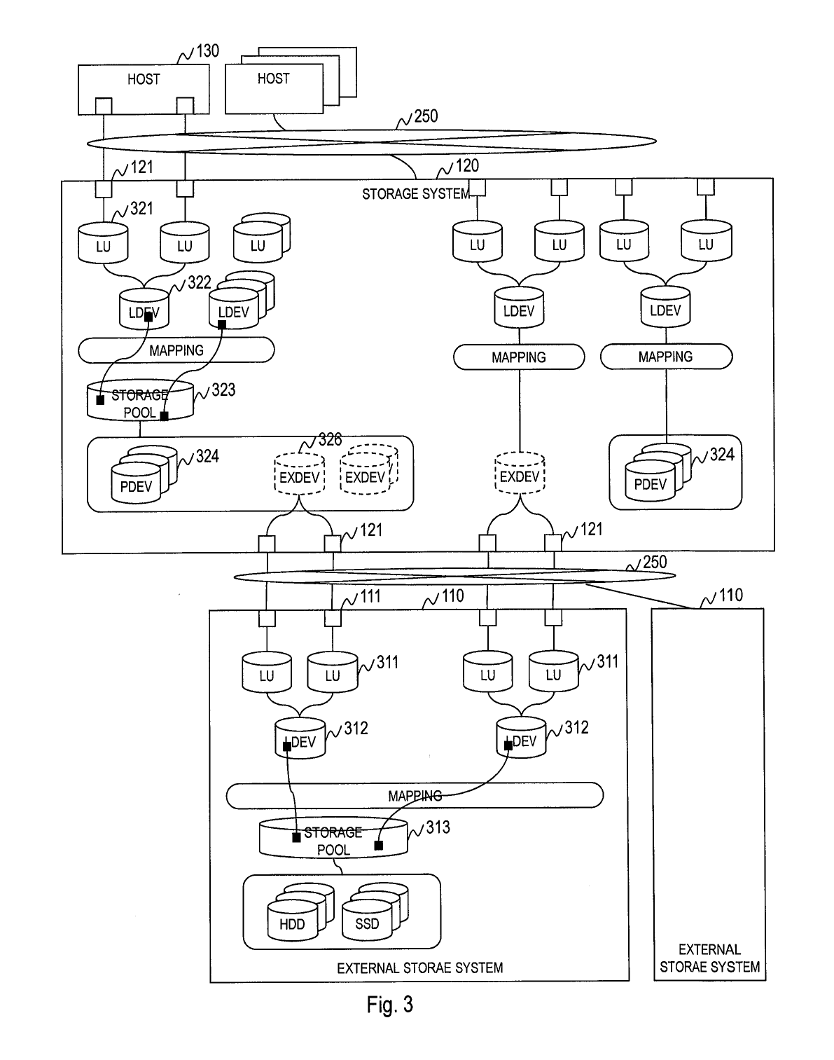

FIG. 3 shows an example of the logical system configuration of the system in FIG. 2. The storage system 120 has logical volumes (LU) 321, logical devices (LDEV) 322, and a storage pool 323. The host 130 accesses data in the storage system's volume (LDEV) 322 data via the LU 321. The host 130 may connect with multiple paths for redundancy. The data of the LDEVs 322 are mapped to the storage pool 323 (physical storage devices) with, for example, RAID, page-based-distributed-RAID, thin-provisioning, or dynamic-tiering technologies. The storage pool 323 includes not only internal physical devices (PDEV 324) such as HDDs 126 and SDDs 127, but also external storage volumes. There can be plural storage pools in a storage system. In FIG. 3, the left side of the storage system 120 shows thin provisioning and the right side of the storage system 120 shows non-thin provisioning.

The external device (EXDEV) 326 in the storage system 120 is the virtual device that virtualizes the LDEV 312 of the external storage system 110. The external device 326 can be connected to the external storage system 110 with multiple paths for redundancy. The LDEV 322 can be mapped direct to the EXDEV 326. In this case, processes of allocating/releasing pool chunks in the storage system 120 are unnecessary.

The external storage system 110 has logical volumes (LU) 311, logical devices (LDEV) 312, and a storage pool 313. It is almost the same as the storage system 120. In this embodiment, the external storage system 110 does not have EXDEV.

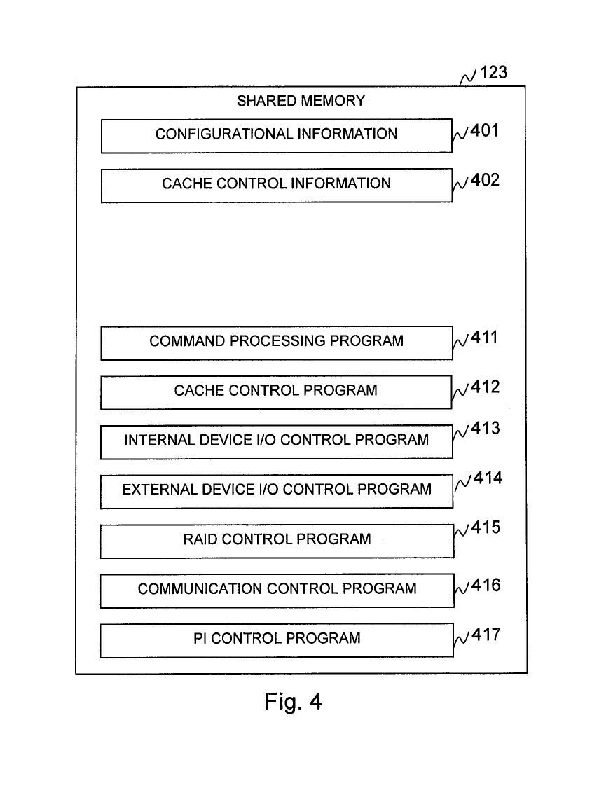

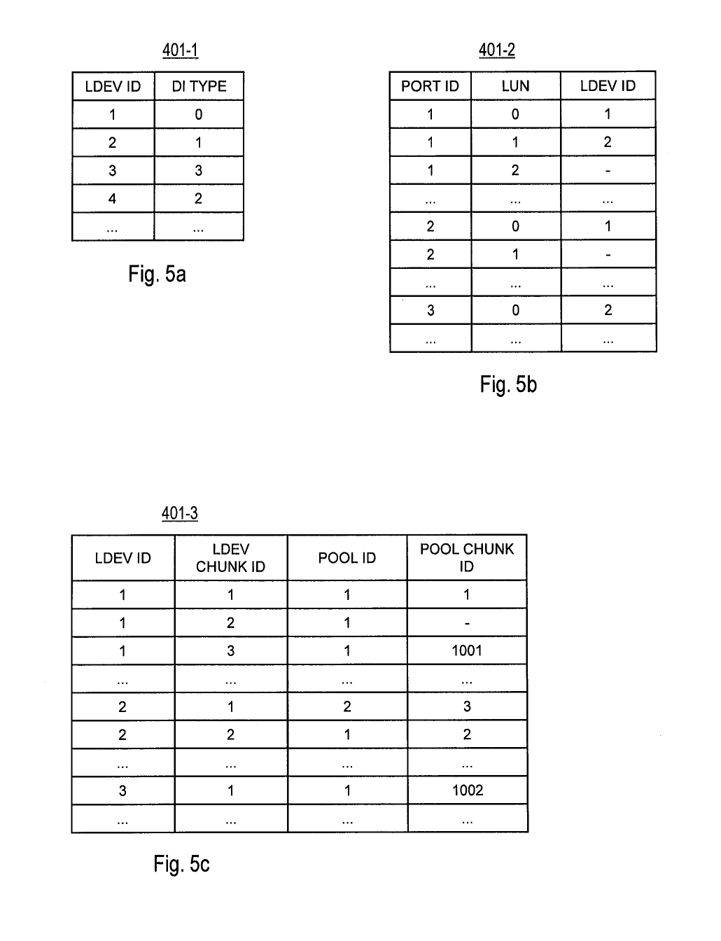

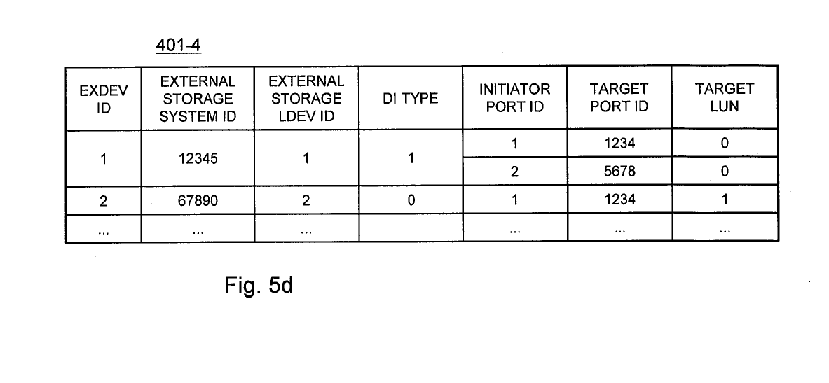

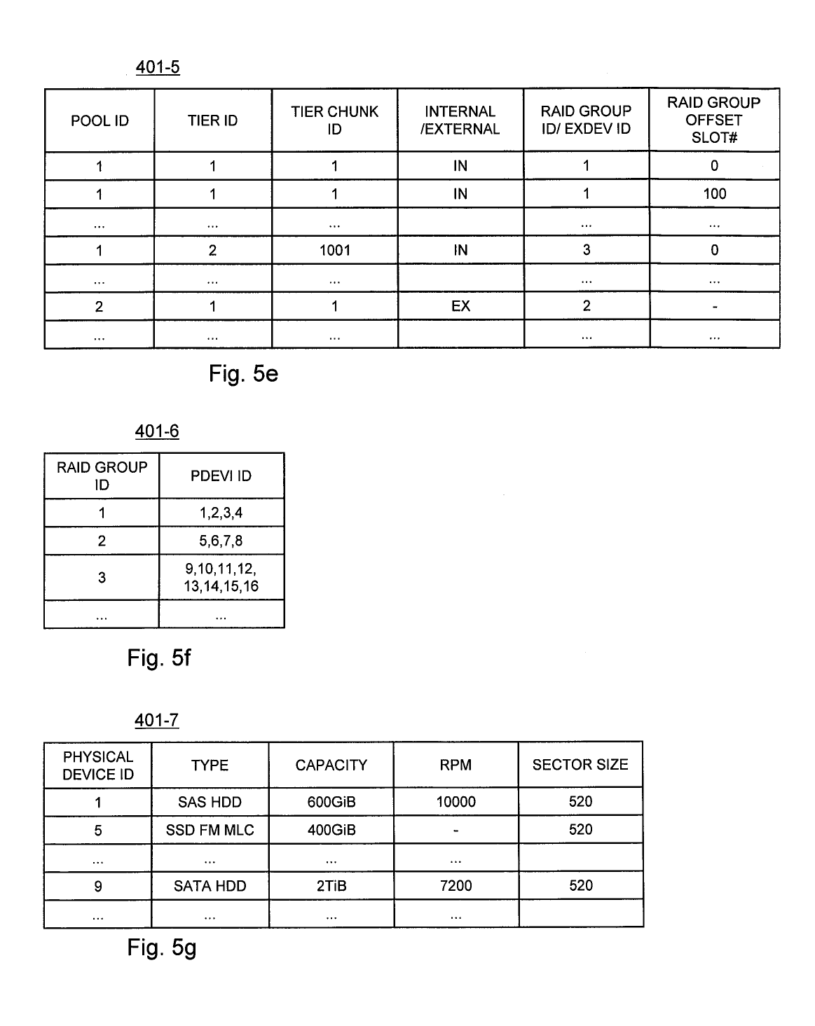

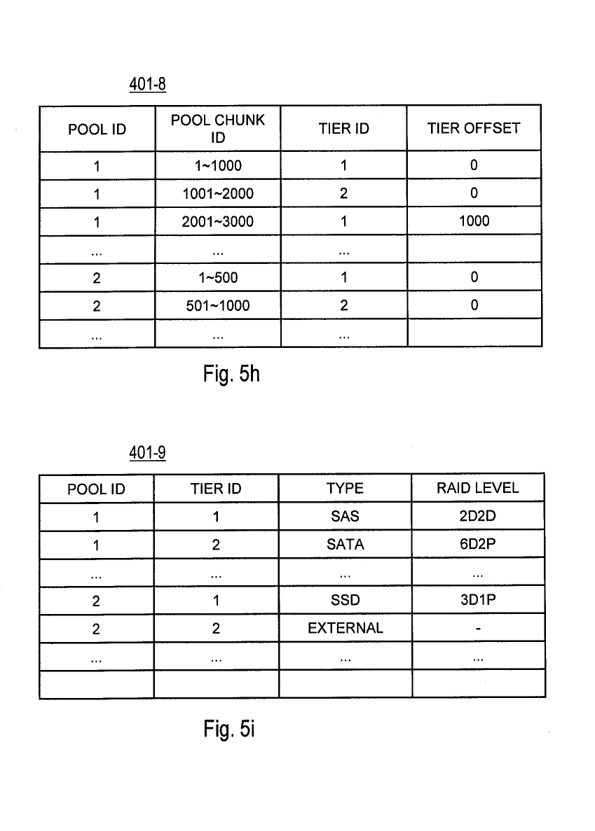

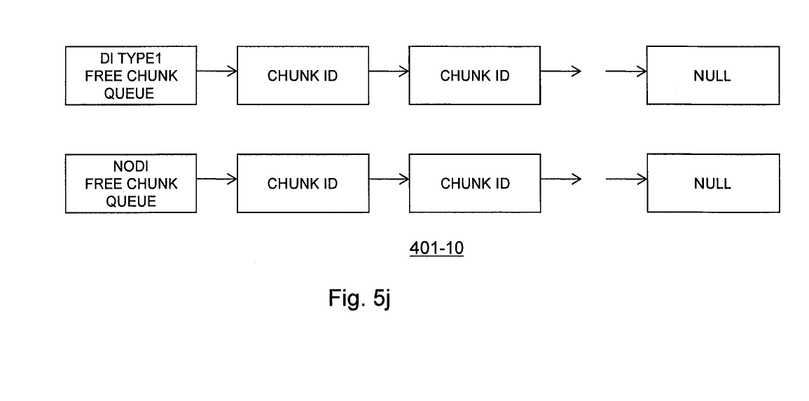

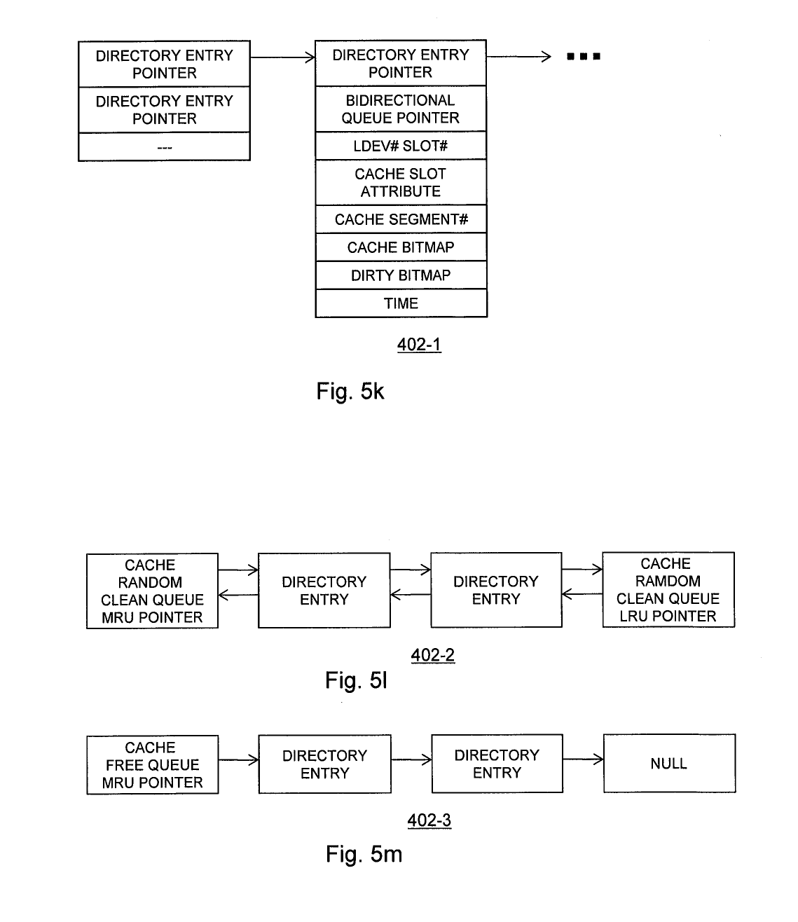

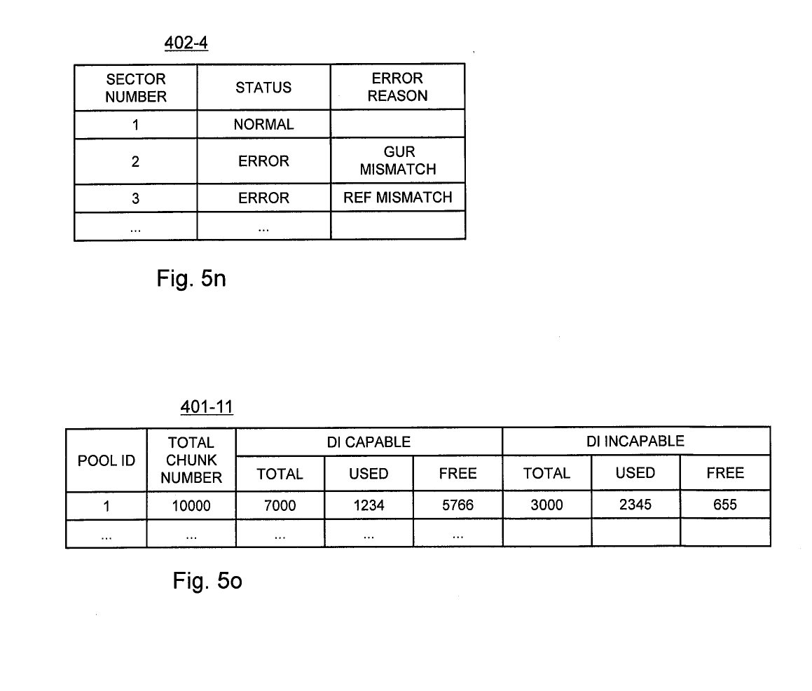

FIG. 4 shows an example of the contents of the shared memory 123 of the storage system 120 of FIG. 2. They include configurational information 401, cache control information 402, command processing program 411, cache control program 412, internal device I/O control program 413, external device I/O control program 414, RAID control program 415, communication control program 416, and PI control program 417. The configuration information 401 is described in connection with FIG. 5. The storage system 120 processes the read/write I/O from the host 130 using the command processing program 411. The storage system 120 processes DI I/O or normal I/O from the host server 130. The storage system 120 calculates parity for RAID control program 415. The storage system 120 transfers data from/to internal physical devices (HDDs, SSDs) using the internal device I/O control program 413. The storage system 120 transfers data from/to external storage systems using the external device I/O control program 414. The storage system 120 processes both DI I/O and normal I/O from/to external storage. The storage system 120 exchanges management information/commands with other storage systems, the management computer 140 and hosts 130 using the communication control program 416. The PI control program 417 checks the PI (GRD and REF). The storage system 120 remaps REF between host target LDEV sector address (LBA) and PDEV/EXDEV sector address. The storage system 120 can have other functional programs and their information such as remote copy, local copy, tier-migration, and so on.

Table Structure

FIG. 5 shows examples of configuration information of the storage system. FIG. 5a shows the DI type information of LDEV in a table 401-1. There can be some types of ID that define REF. See Martin K. Petersen, Linux Data Integrity Extension, Proceedings of the Linux Symposium, Jul. 23-26, 2008, Ottawa, Ontario, Canada, pages 151-156, at section 2.1, and the description of FIG. 43 above. DI type 0 means the LDEV is incapable of processing DI I/O command from the host server. The DI type is defined when LDEV is creating/formatting from the management server or host server. It is possible that DI capability or DI type information is part of LDEV. Part of LDEV is managed by, for example, LBA bound, or beginning LBA and length. The user indicates the part information via the management server or host server to the storage system. In this case, the storage system allocates DI capable pool chunk to DI capable part. The DI I/O command requested address area includes DI incapable blocks; the storage system may return with an error indication.

FIG. 5b shows a mapping table 401-2 of LU to LDEV. FIG. 5c shows a mapping table 401-3 of LDEV to storage pool. It is possible that LDEV can use multiple storage pools. FIG. 5d shows Information of EXDEV in a table 401-4. The DI TYPE is DIF capability and DIF type of the external volume. There can be some types of DI that define REF. See Martin K. Petersen, Linux Data Integrity Extension, Proceedings of the Linux Symposium, Jul. 23-26, 2008, Ottawa, Ontario, Canada, pages 151-156, at section 2.1. Type 0 means that the external storage volume is DI I/O incapable. Types of DI are obtained from external storage by, for example, SCSI inquiry command or input by the management server. It is possible that the storage system manages DI capable/incapable information per external storage system.

FIG. 5e shows a mapping table 401-5 of pool chunk to tier. FIG. 5f shows information of RAID groups in a table 401-6. FIG. 5g shows information of physical devices (e.g., HDDs, SSDs) in a table 401-7. Sector size 520 means that the PDEV can store 512 byte data with 8 byte PI. FIG. 5h shows information of pool tier in a table 401-8. FIG. 5i shows a mapping table 401-9 of tier chunk to EXDEV/RAID group.

FIG. 5j shows information of free chunk in a diagram 401-10. Free chunk is managed using, for example, queuing technology. DI I/O capable and DI I/O incapable chunks are managed separately to make it easy to search which chunk should be allocated to LDEV. It is possible that there are queues of each type of DI. The storage system allocates DI chunks to LDEV(DI) and NODI chunk to LDEV(NODI) using the queues.

FIG. 5k shows cache directory management information in a table 402-1. A hash table is linked to multiple pointers that have the same hash value from LDEV#+slot#. Slot# is the address on LDEV (1 slot is 512 Byte×N). Segment is the managed unit of cache area. Each cache is managed with segment. Cache slot attribute is dirty/clean/free. Segment# is the address on cache area, if the slot is allocated cache area. Cache bitmap shows which blocks (512 Byte userdata) are stored on the segment.

FIG. 5l shows clean queue LRU management information in a diagram 402-2. FIG. 5m shows free queue management information in a diagram 402-3. FIG. 5n shows sector information in a table 402-4. An ERROR status means the storage system finds failure, such as data and GRD un-matching. FIG. 5o shows information of pool chunk usage in a table 401-11. Pool chunk number is managed separately for DI capable chunk and DI incapable chunk. Using this information, the storage system can send to the management server/host DI capable and DI incapable pool capacity utilities separately.

Flow Diagrams

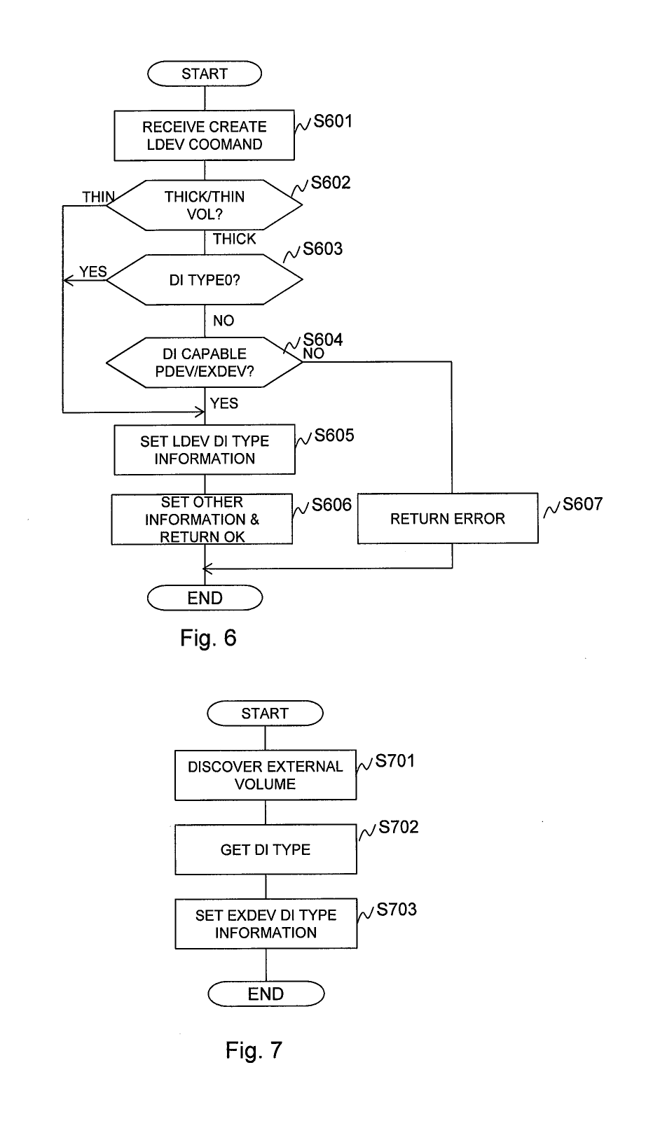

FIG. 6 is a flow diagram illustrating an example of LDEV creation according to the first embodiment. DI types of LDEV is defined and set during LDEV creation. It is possible during LDEV formatting. In S601, the storage system receives a create LDEV command from the management server or host server. In S602, the storage system checks whether the LDEV is to 1 to 1 or thin provisioning volume (i.e., whether it is directed mapped to EXDEV). If yes, the process goes to S603; if no, the process goes to S605. In S603, the storage system determines whether the DI type is 0 or not. If yes, the process goes to S605; if no, the process goes to S604. In S604, the storage system checks whether the EXDEV is DI capable or not. If yes, the process goes to S605; if no, the storage system returns with an error in S607 and the procedure ends because the storage system cannot read from/write to the external storage LDEV with PI. In S605, the storage system sets the DI type information into table. In S606, the storage system sets other information.

FIG. 7 is a flow diagram illustrating an example of adding EXDEV. DI type of EXDEV is defined while adding EXDEV. DI type is obtained from the external storage system by, for example, SCSI inquiry command. It is possible that DI type is defined by the management server or host server. The storage system discovers external volume (S701), gets the DI type (S702), and sets EXDEV DI type information (S703).

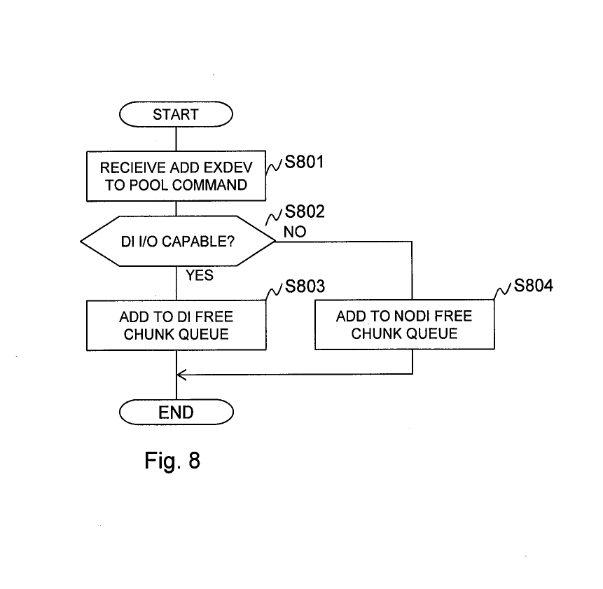

FIG. 8 is a flow diagram illustrating an example of adding EXDEV to storage pool according to the first embodiment. The storage system receives a command to add EXDEV to pool (S801) and checks whether the EXDEV is DI capable (S802). If the DI type of the EXDEV is “0” (DI I/O incapable), the chunks of EXDEV are added to NODI free chunk queue (S804); otherwise, the chunks of DI I/O capable EXDEV are added to DI free chunk queue (S803). It is possible to have different free queue DI types. This process flow is also used when adding internal PDEV or internal PDEV group or internal LDEV to the storage pool, if there are both DI capable and DI incapable internal device types.

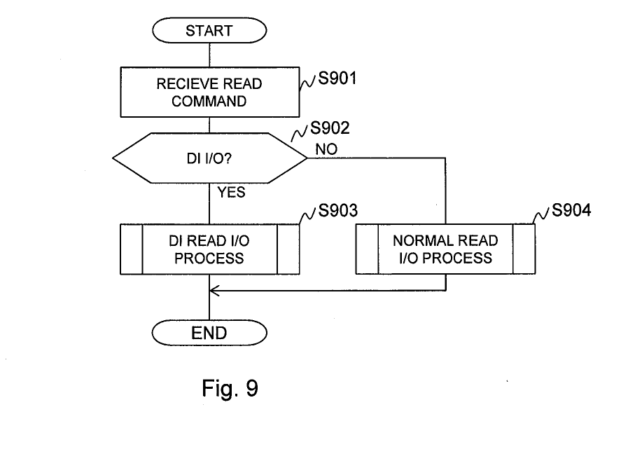

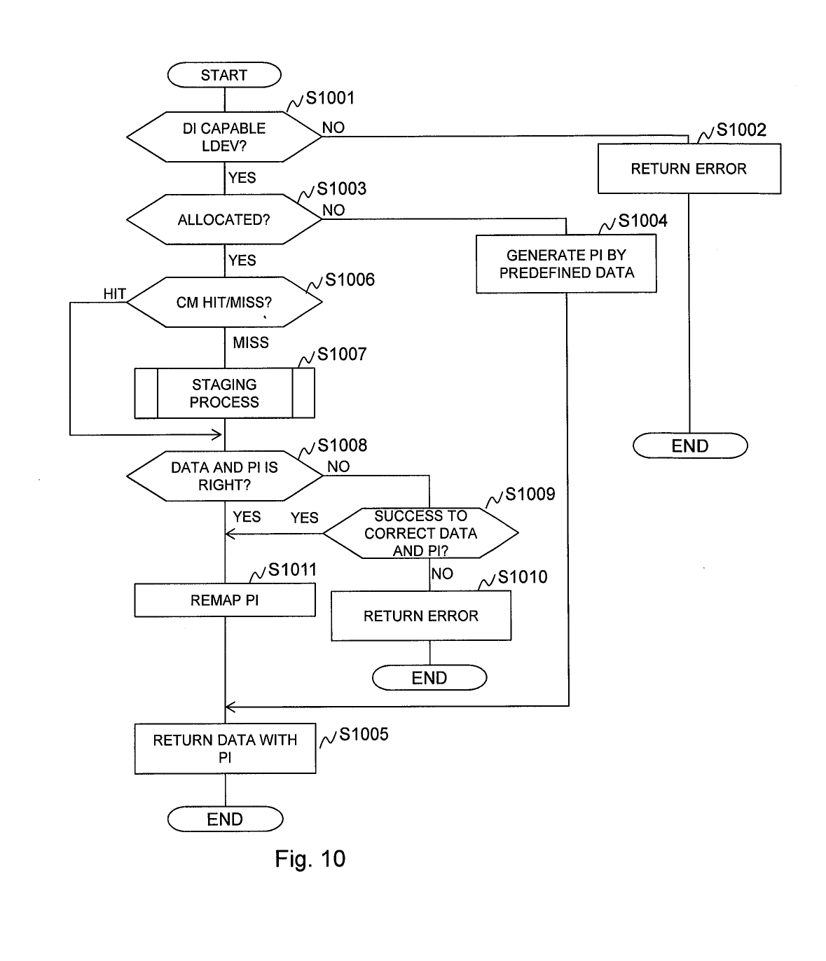

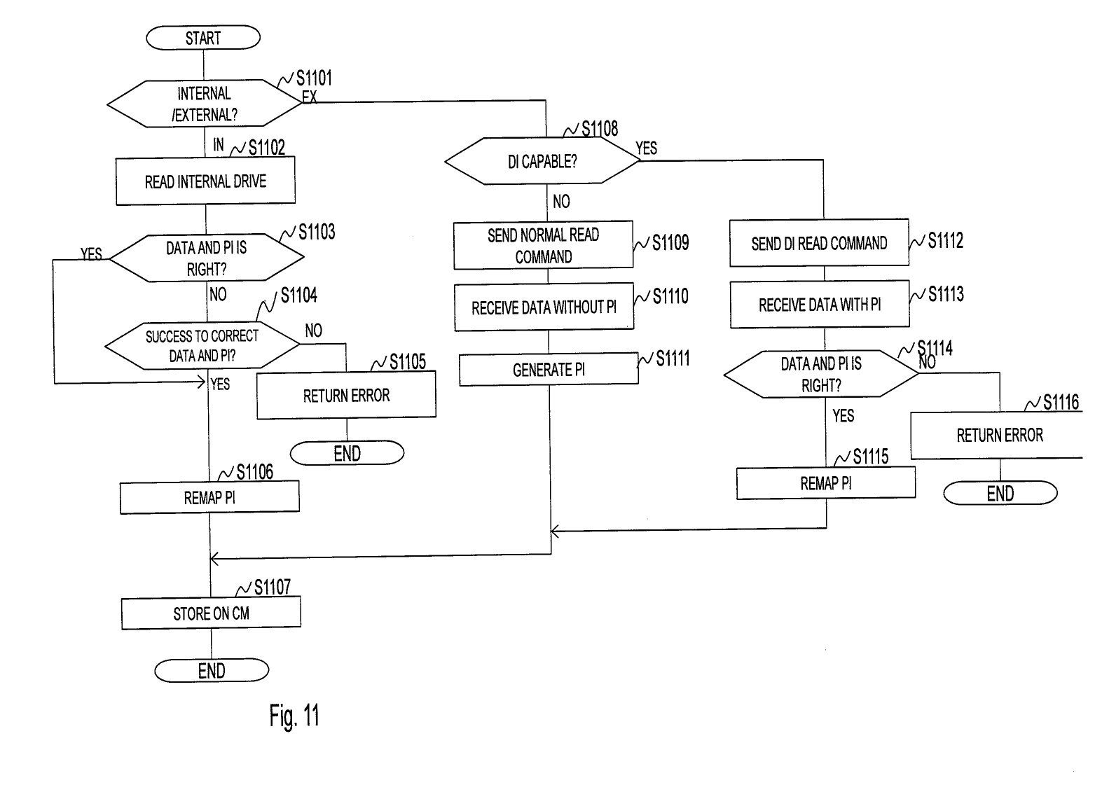

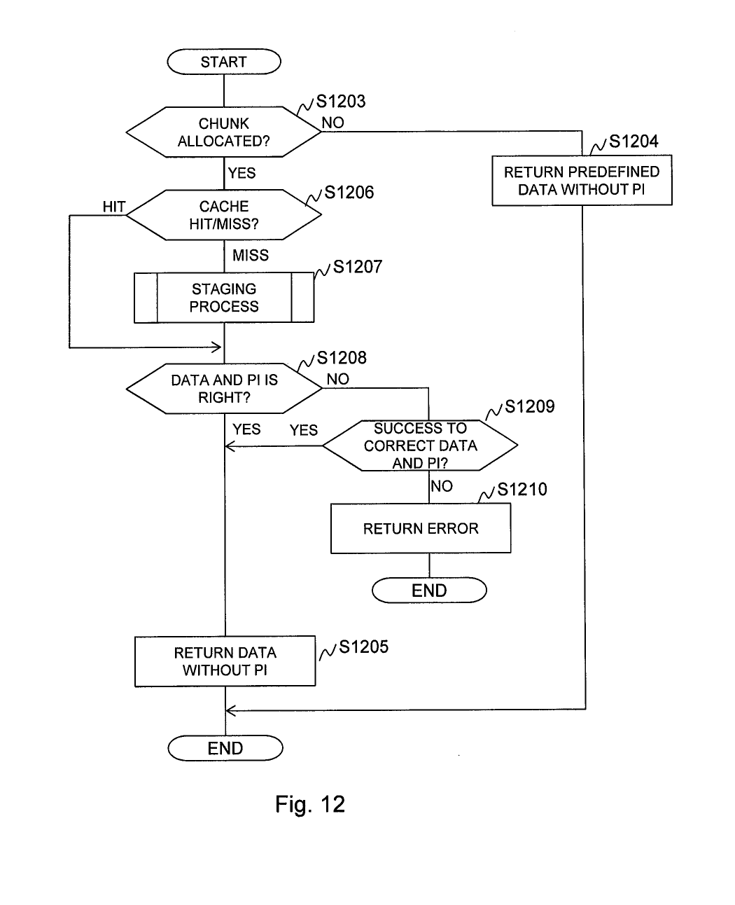

FIG. 9 is a flow diagram illustrating an example of a read I/O process. The storage system receives a read I/O command from the host server (S801) and determines whether the command type is DI or not (normal) (S902). If DI, the storage system proceeds with DI read I/O process (S903) (see FIG. 10); if not, the storage system proceeds with normal read I/O process (S904) (see FIG. 12). It is possible that the command has the DI type. It is possible the command type is not different from DI or not. The storage system selects the process based on the target LDEV's DI type.

FIG. 10 is a flow diagram illustrating a DI read I/O process. For simplicity, in this embodiment, the request is 1 block size (512 Bytes data+8 Bytes PI). In S1001, the storage system checks whether the target LDEV is DI I/O capable or not. If yes, the process goes to S1003; if no, the storage system returns an error (S1002) and the procedure ends. In S1003, the storage system determines whether the requested address is allocated or not. If the requested address is not allocated chunk yet, the storage system generates the PI by predefined data (e.g., all zeroes) (S1004) and returns data with PI (S1005). GRD is based on predefined data pattern such as all 0. REF is based on DI type of LDEV and requested address. If the requested address is allocated, the storage system checks for CM (Cache Memory) hit or miss (S1006). Hit means the required data exists on CM, and MISS means the required data does not exist on CM. If hit, the process goes to S1008; if miss, the process goes to S1007 and then S1008. The staging process in S1007 is described in FIG. 11. In S1008, the storage system checks CRC data in GRD tag in PI and userdata. If the data and PI are right, the process goes to S1011; if not, the process goes to S1009. In S1009, the storage system tries to correct data using, for example, RAID technology (RAID1 reads mirror data of RAID1; RAIDS/6 reads parity data and other data in parity group and calculates the data). If it is successful, the process goes to S1011; otherwise, the storage system returns an error in S1010 (updates cache information of sector to ERROR) and the procedure ends. In S1011 to remap PI, the storage system updates the REF value for sending to the host server. That value is calculated based on DI type and command. Type1 REF matches lower bits of LBA. Type2 REF matches the seed value in the SCSI command +offset from beginning of I/O.

FIG. 11 is a flow diagram illustrating an example of the staging process. In S1101, the storage system checks whether the staging is internal or external. If internal, the process goes to S1102; if external, the process goes to S1108. In S1102, the storage system reads the internal drive. In S1103, the storage system checks whether the data and PI are right. If yes, the process goes to S1106; if no, the storage system tries to correct the data and PI and the process goes to S1104. In S1104, if the storage system succeeds in correcting the data and PI, the process goes to S1106; if not, the storage system returns an error in S1105 and the procedure ends. In S1106, the storage system remaps PI.

In S1108 (external storage system), the storage system checks the DI capability of the EXDEV. If it is DI capable, the process goes to S1112-S1115. If it is DI incapable, the storage system sends a normal read command (S1109), receives data without PI (S1110), and generates PI (S1111). In S1111, the storage system also calculates CRC from data and sets the GRD value, because the received data does not have PI. In S1112, the storage system sends a DI read command and, in S1113, it receives data with PI. In S1114, the storage system checks whether the data and PI are right by checking GRD and REF. The REF value depends on the DI type. If yes, the storage system remaps PI in S1115; if no, the storage system returns an error in S1116 and the procedure ends.

In S1106, S1111, and S1115, the storage system updates REF value for storing CM. That value is based on internal protection protocol (e.g., address on physical drives or address on EXDEV). After S1106, S1111, or S1115, the storage system stores the value on CM in S1107 and the procedure ends. The storage system can use a DI I/O command to the external storage system, if the host target LDEV is DI incapable. It is good for protecting data integrity between the storage system and the external storage system.

FIG. 12 is a flow diagram illustrating an example of a normal read I/O process. In S1203, the storage system checks whether a chunk is allocated or not. If yes, the process goes to S1206; if no, the storage system returns predefined data without PI in S1204 and the procedure ends. In S1206, the storage system checks whether there is cache hit or miss. If hit, the process goes to S1208; if miss, the storage system performs a staging process in S1207 (see FIG. 11) and the process goes to S1208. In S1208, the storage system checks whether the data and PI are right. If yes, the storage system returns data without PI in S1205 and the procedure ends. If no, the storage system tries to correct the data and PI and the process goes to S1209. In S1209, the storage system checks whether the correction is successful. If yes, the storage system returns data without PI in S1205 and the procedure ends. If no, the storage system returns an error in S1210 and the procedure ends. In S1204 and S1205, the storage system removes the PI and sends userdata to the host server without PI.

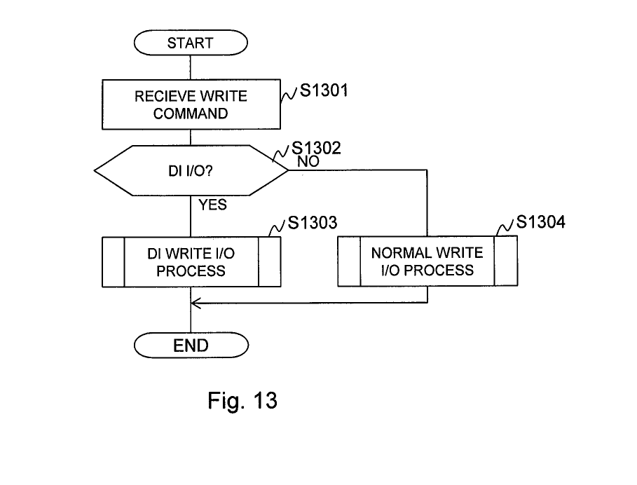

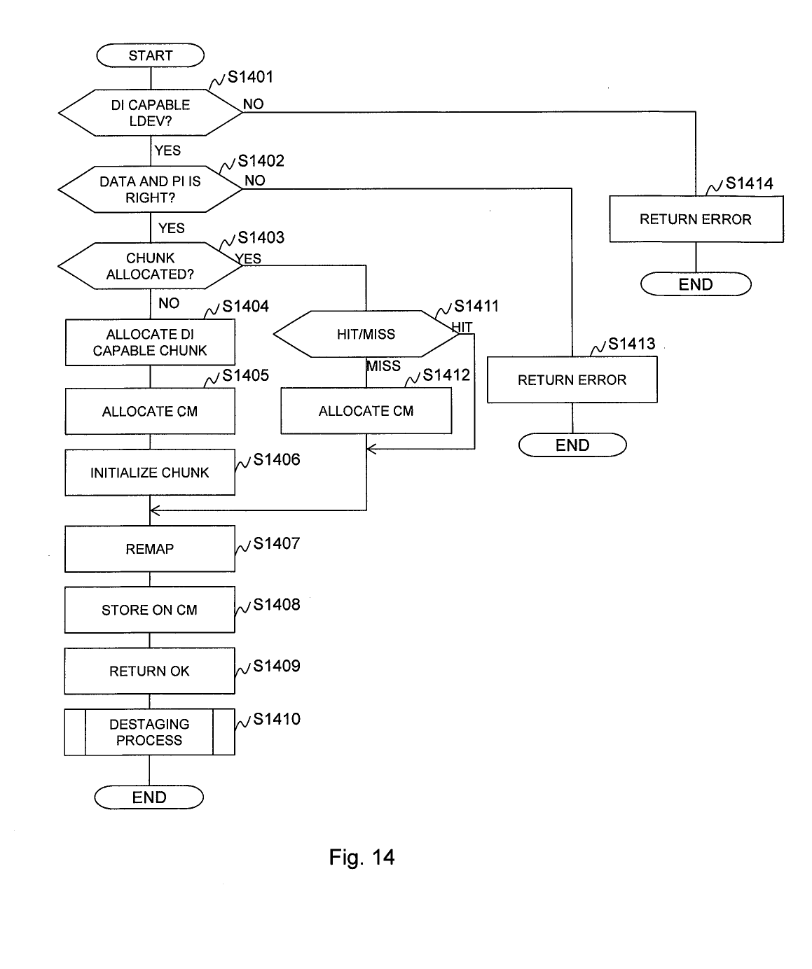

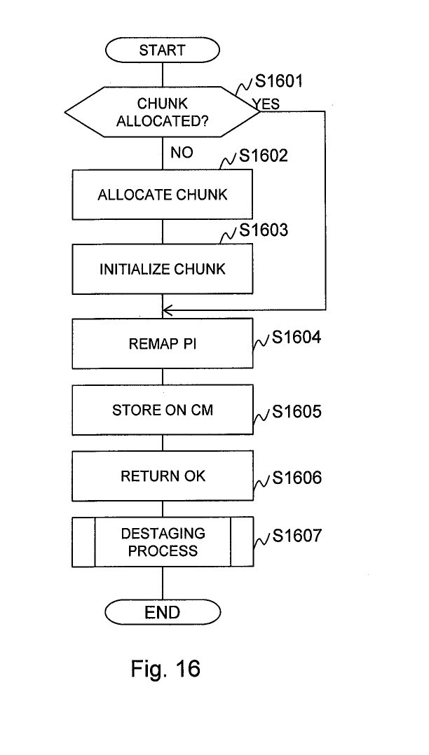

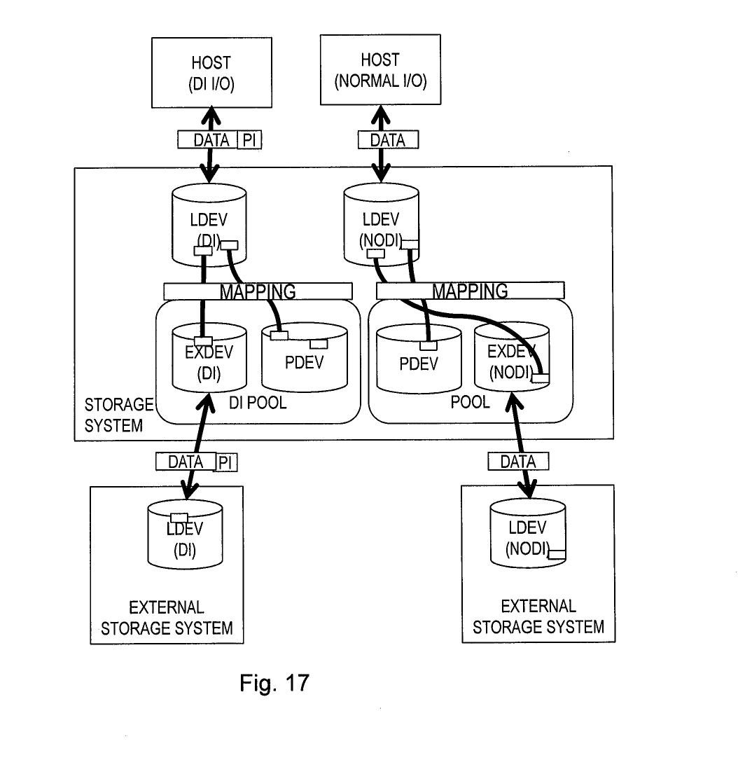

FIG. 13 is a flow diagram illustrating an example of a write I/O process. The storage system receives a write command from the host server (S1301) and checks the command type to determine whether it is DI I/O or not. If yes, the storage system proceeds with a DI write I/O process (S1303) (see FIG. 14); if no, the storage system proceeds with a normal write I/O process (S1304) (see FIG. 16). It is possible that the command has DI type. It is possible the command type is not different from DI or not. The storage system selects the process based on target LDEV's DI type.

FIG. 14 is a flow diagram illustrating an example of a DI write I/O process. The storage system checks whether it is a DI capable LDEV or not. If yes, the process goes to S1402. If no, the storage system returns an error (S1414) and the procedure ends. In S1402, the storage system checks the integrity received userdata and PI(GRD, REF) to determiner whether the data and PI are right. REF is based on DI type. If yes, the process goes to S1403. If no, the storage system returns an error (S1413) and the procedure ends. In S1403, the storage system checks if the requested address is allocated pool chunk (physical area for storing) or not. If yes, the storage system checks for hit or miss (S1411) and, if miss, allocates CM (S1412), and the process goes to S1407. If no, the storage system allocates DI capable chunk (S1404), allocates CM (S1405), and initializes chunk (S1406), and the process goes to S1407. In S1404, the storage system allocates DI I/O capable chunk for keeping PI from the host server. The allocation of DI capable pool chunk to DI capable LDEV occurs not only while receiving write I/O, but also during other times such as data migration inside the storage system for purposes of, for example, as balancing or tiering. In S1406, the chunk may be larger than the received data, and hence the storage system initializes the other blocks in the chunk. It involves filling predefined data such as “0x00” and PI. The REF value is based on internal protection protocol. This step may be done asynchronously or after returning the host I/O command.

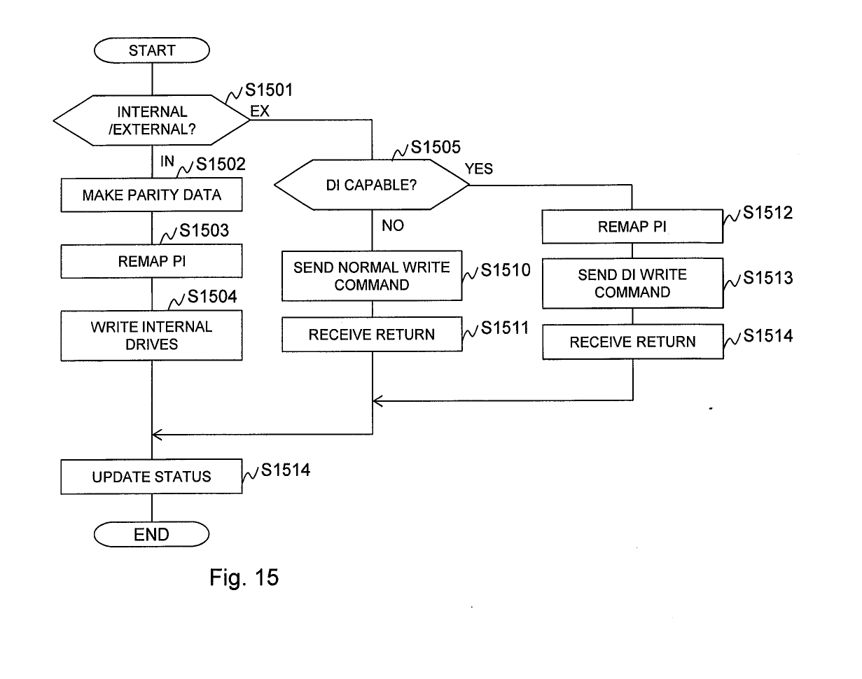

In S1407, the storage system updates the REF value for storing CM. That value is based on internal protection protocol. The storage system then stores the value on CM (S1408), returns OK (S1409), and performs a destaging process (S1410) (see FIG. 15), and the procedure ends. The step in S1410 may be done asynchronously. It is conventional write after technology.

FIG. 15 is a flow diagram illustrating an example of the destaging process. In S1501, the storage system checks whether the destaging is internal or external. If internal, the process goes to S1502; if external, the process goes to S1505. In S1502, the storage system makes redundant data such as parity data of RAID technology. In S1503, the storage system updates REF value for storing PDEV (remaps PI). The storage system also writes redundant data to internal drives (S1504) and updates status (S1514). In S1505 (external), the storage system checks the DI type to determine whether it is DI capable. If yes, the storage system updates REF value for writing external storage volume (remaps PI) (S1512), sends a DI write command (S1513), receives a return (S1514), and updates status (S1514). The REF value is based on DI type of external storage volume. If no, the storage system sends a normal write command (S1510), receives a return (S1511), and updates status (S1514).

FIG. 16 is a flow diagram illustrating an example of a normal write I/O process. In S1601, the storage system checks whether a chunk is allocated or not. If yes, the process goes to S1604; if no, the storage system allocates a pool chunk to LDEV (S1602) and initiates the chunk (S1603) and the process goes to S1604. It is better that the allocated chunk is DI incapable, but the storage system can allocate DI capable pool chunk to NODI LDEV (for example, when there are no free DI incapable chunks but there are free DI capable chunks). After the storage system has free DI incapable chunks, the storage system may search DI incapable LDEV, and if DI capable chunks are allocated to the LDEV, the storage system migrates DI capable chunks to DI incapable chunks using data migration technologies inside the storage system. In S1603, the chunk may be larger than the received data, and hence the storage system initializes the other blocks in the pool chunk (e.g., filling predefined data and PI). The REF value is based on internal protection protocol. This step may be done asynchronously or after returning command. In S1604, the storage system updates the REF value for storing CM (remaps PI). That value is based on internal protection protocol. The storage system stores the value on CM (S1605), returns OK (S1606), and performs a destaging process (S1607) (see FIG. 15).

Second Embodiment

System Configuration

FIG. 17 is a system block diagram illustrating an outline of data integrity protection according to the second embodiment. The main difference from the first embodiment (see FIG. 1) is that there are DI capable storage pool and DI incapable storage pool in the second embodiment. The storage system manages the two pools separately. DI capable LDEV is allocated storage area from the DI capable storage pool.

Table Structure

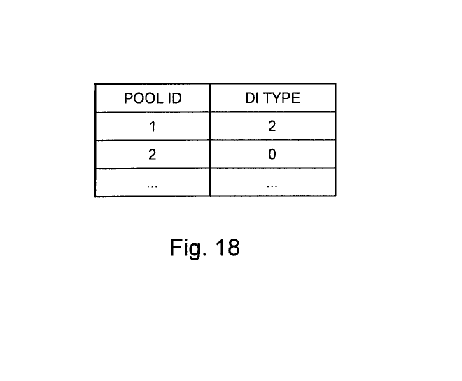

FIG. 18 show an example of DI type information of storage pool according to the second embodiment. In the second embodiment, the storage pool also has DI type information. It is possible that it is DI capable/incapable information. This information is used when adding internal PDEV or internal PDEV group or internal LDEV to the storage pool, if there are both DI capable and DI incapable internal device types.

Flow Diagrams

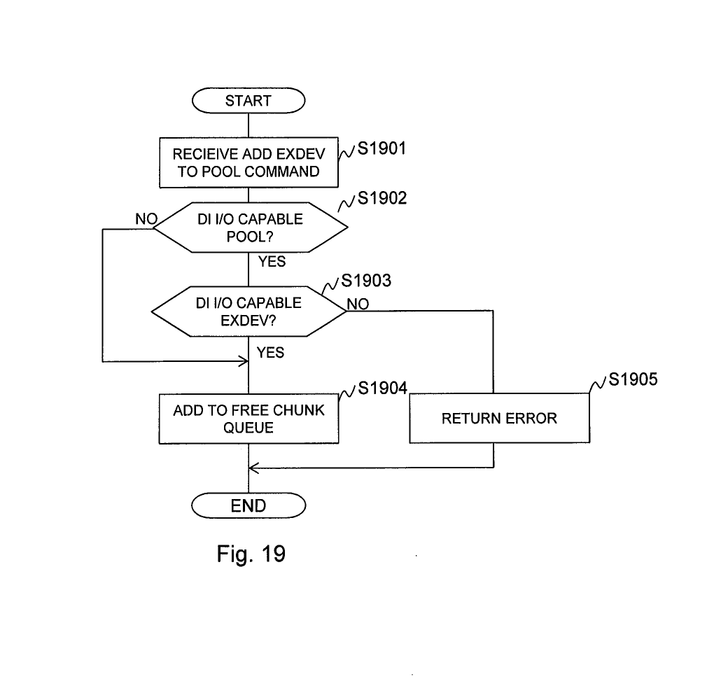

FIG. 19 is a flow diagram illustrating an example of adding EXDEV to storage pool according to the second embodiment. The storage system receives a command to add EXDEV to pool (S1901) and checks whether the pool is DI I/O capable (S802). If no, the storage system adds to the free chunk queue (S1904) and the procedure ends. If yes, the storage system checks whether the EXDEV is DI I/O capable. If yes, the storage system adds to the free chunk queue (S1904) and the procedure ends. If no, the storage system returns an error (S1905) and the procedure ends. In S1902 and S1903, the storage system checks and adds DI capable EXDEV to DI capable storage pool. It is possible this flow is used to adding internal devices to a storage pool. In S1904, according to the second embodiment, the storage system can manage free pool chunks in one queue per storage pool. Because DI capable or not is defined in the storage pool. DI capable storage pool includes only DI capable devices, so that all pool chunks are DI capable.

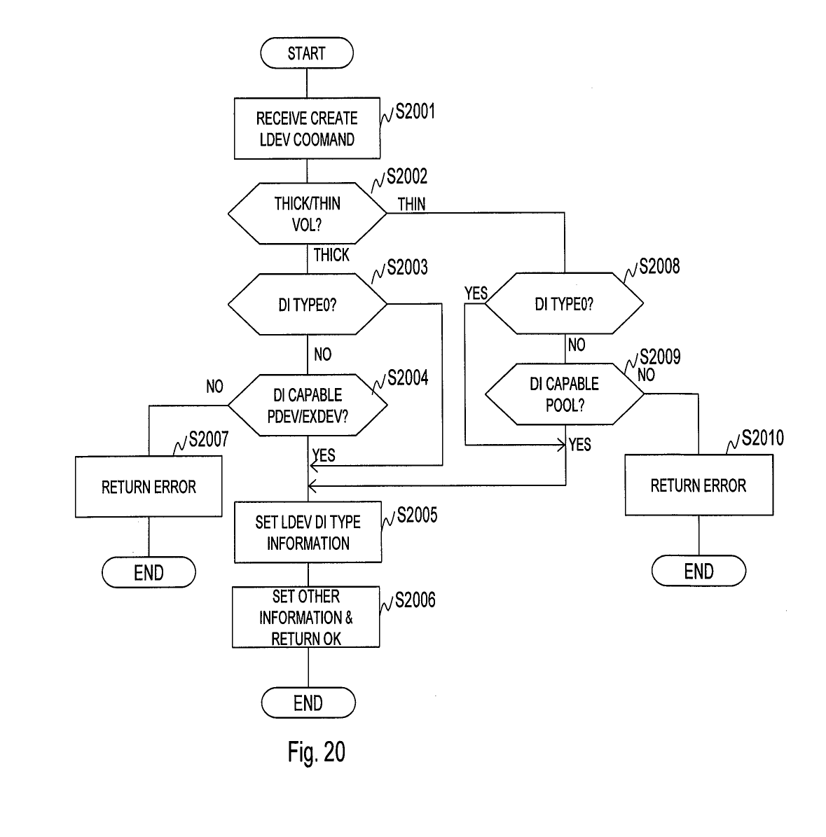

FIG. 20 is a flow diagram illustrating an example of LDEV creation according to the second embodiment. The main difference from the first embodiment (FIG. 6) is the additional steps of checking DI capability of the storage pool where LDEV is indicated to be added (S2008 and S2009). Steps S2001-2007 are similar to steps S601-607 of FIG. 6. In S2008, the storage system checks whether the DI type of LDEV is 0 or not. If yes, the process goes to S2005 and S2006. If no, the storage system checks whether the pool is DI capable or not (S2009). If yes, the process goes to S2005 and S2006. If no, the storage system returns an error (S2010) and the procedure ends.

Third Embodiment

System Configuration

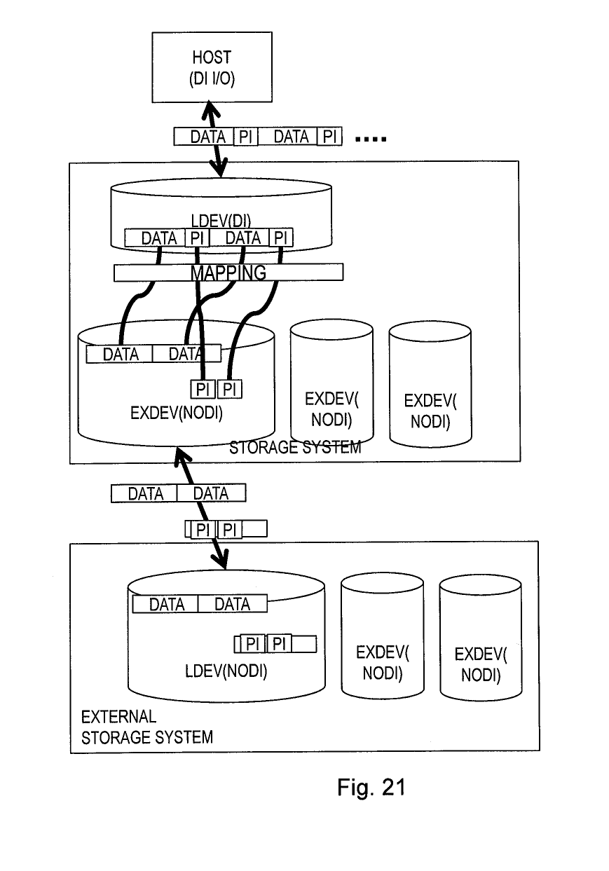

FIG. 21 is a system block diagram illustrating an outline of data integrity protection according to the third embodiment. The main difference from the first embodiment (see FIG. 1) is that the storage system stores the PI separately from the userdata. This embodiment works well for LDEV and in an environment where the pool data is not 1:1 (e.g., the storage system compresses LDEV userdata and stores it in the pool area (N on LDEV to M size on pool). This embodiment also works well in another example involving compression or deduplication or discard particular pattern data, with different plural LDEV PIs to less or no pool data.

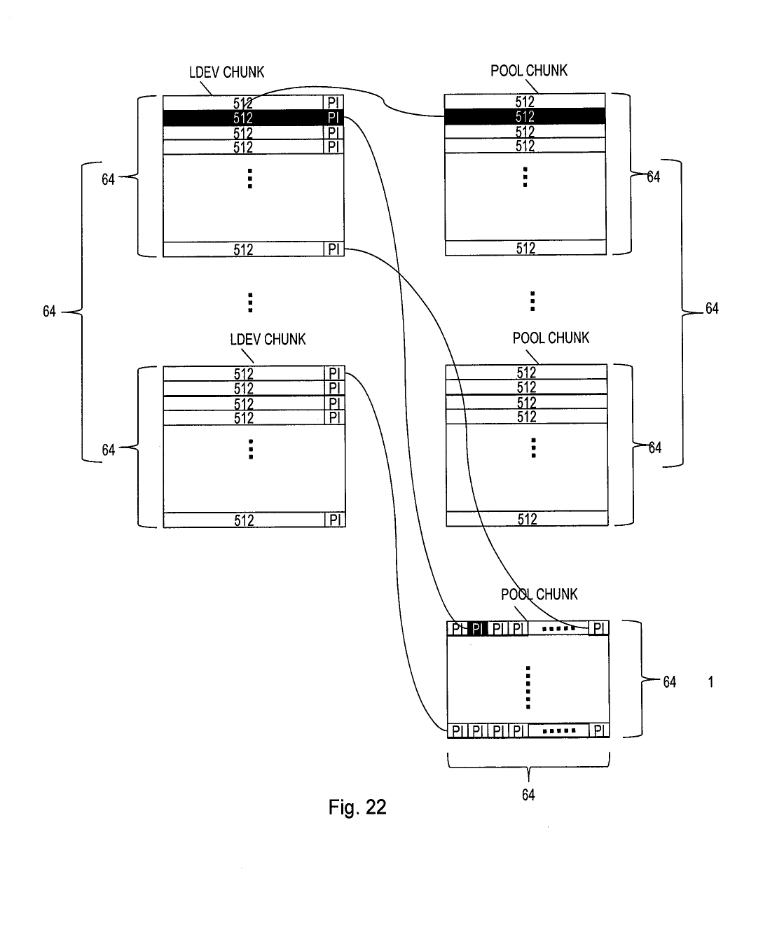

FIG. 22 is a diagram illustrating LDEV block to pool block mapping according to the third embodiment. The storage system stores PI in different pool chunks from the userdata chunks. 64 PI can be stored in 1 block (8 bytes×64=512 bytes). Pool chunk unit is 64 blocks, so that 1 pool chunk can store 64×64 PIs. The LDEV chunk unit is 64 blocks that include PI. 64 LDEV chunks are mapped to 64 userdata pool chunks and 1 PI pool chunk. These numbers are the most capacity efficient ratio, but it is possible that chunk units are of other sizes (e.g., 64×10 blocks).

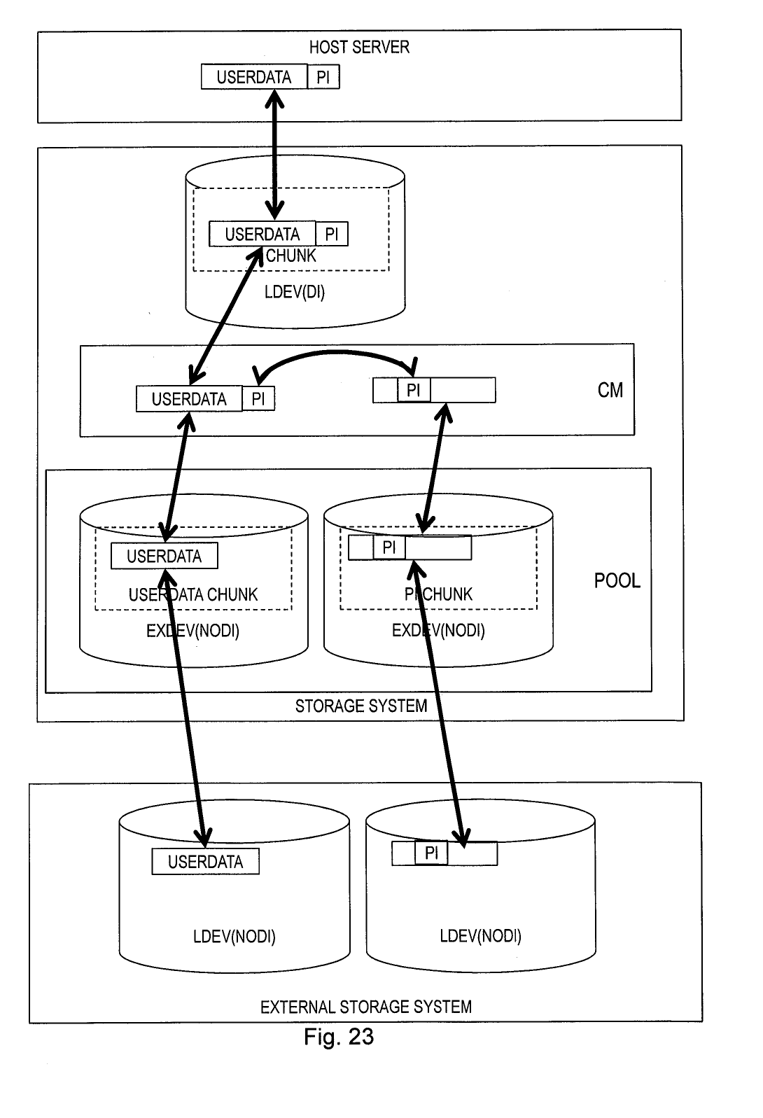

FIG. 23 is a diagram illustrating an outline of placing userdata and PI according to the third embodiment. The storage system puts userdata and PI to the same block on CM. The storage system copies PI to different blocks on CM. The storage system copies the PI from PI block to userdata block on CM. It is possible that PI is combined with or separated from userdata on transfer buffer of I/O controller and not on CM. It is possible that PI is combined with or separated from userdata between transfer buffer of I/O controller and CM.

Table Structure

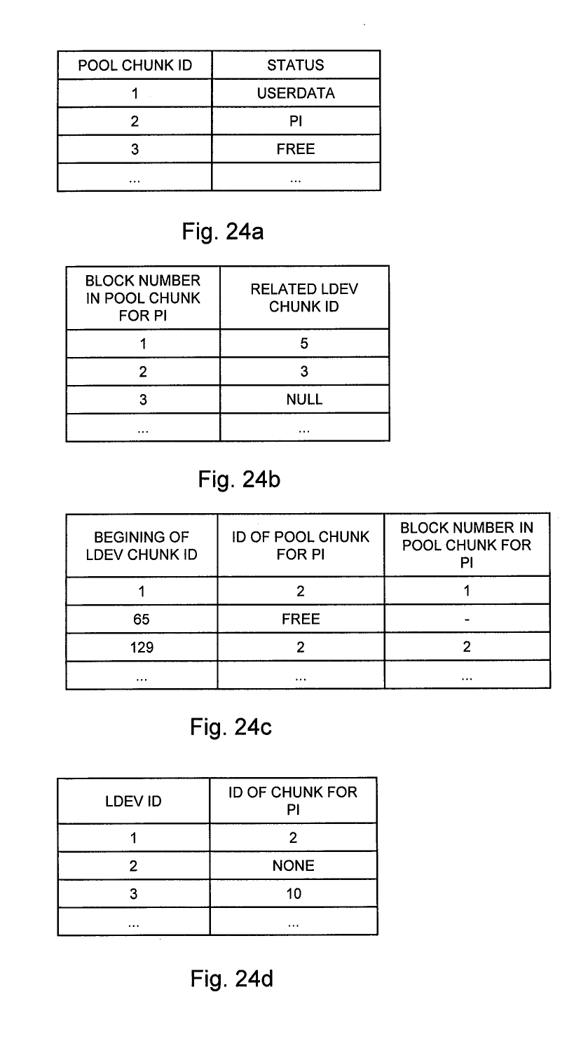

FIG. 24a shows an example of mapping between LDEV and pool. Each pool chunk has a status of storing userdata, storing PI, or free. FIG. 24b shows an example of mapping between pool chunk for PI to LDEV chunk for userdata. Each block in pool chunk for PI has LDEV chunk ID where the PI originally related userdata are stored. FIG. 24c shows an example of mapping between LDEV chunk and pool chunk for PI. This information shows that PI of LDEV chunk is stored in which pool chunk for PI and which block in pool chunk for PI. FIG. 24d shows an example of pointer from LDEV ID to using chunk for PI. Which PI chunk has free blocks for PI is managed by a queue. LDEV ID has pointer to the PI chunk that has free block. PI Chunk also has pointer to the next PI chunk by queue. It is possible that free block of PI chunk is managed not by queue technology but by some other technology such as free/used bitmap. It is possible that mapping table of LDEV to pool userdata is different in such as data compression or data deduplication virtualization. It is possible that only some part of PI such as APP is stored to keep information by OS/application.

Flow Diagrams

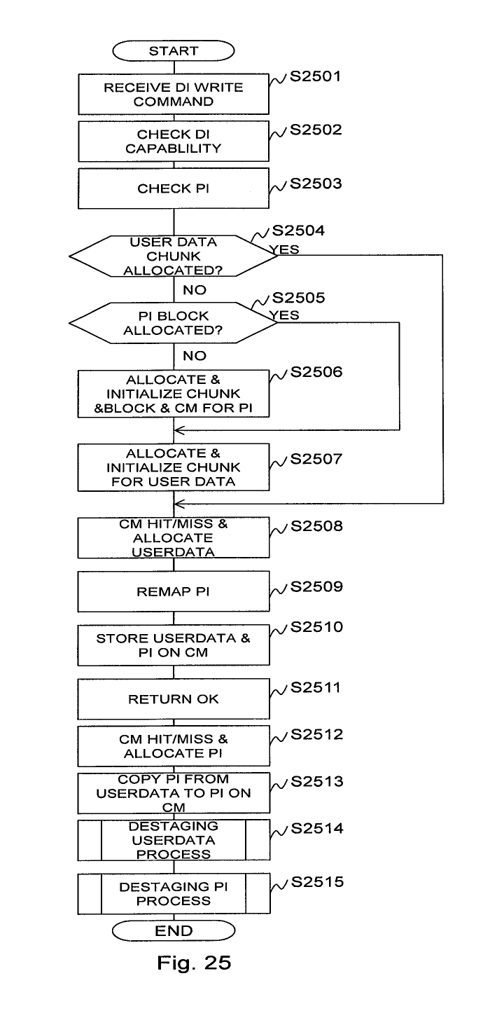

FIG. 25 is a flow diagram illustrating an example of a write I/O process according to the third embodiment. For simplify, normal write command case processes or error case processes are omitted in this figure. The storage system receives a DI write command (S2501), checks the DI capability (S2502) and checks the PI (S2503). In S2504, the storage system checks whether the userdata chunk is allocated. If yes, the process goes to S2508. If no, the storage system checks whether PI block is allocated (S2505). If yes, the process goes to S2508. If no, the storage system allocates block for PI and initializes the chunk and block and the CM for PI (S2506). If the PI chunk that is already allocated is full, the storage system allocates a new pool chunk for PI. If the chunk for userdata is already allocated by another write command, the chunk for PI is allocated already.

In S2508, the storage system check CM hit/miss and allocates userdata. The storage system remaps PI (S2509), stores userdata and PI on CM (S2510), and returns OK (S2511). In S2512, the storage system copies PI on CM from PI beside userdata block to PI block in chunk for PI. It is possible that PI separation from userdata is done on transfer buffer of I/O controller and PI is directly stored to PI block on CM. The storage system copies PI from userdata to PI on CM (S2513), performs destaging userdata process (S2514), and perform destaging PI process (S2515).

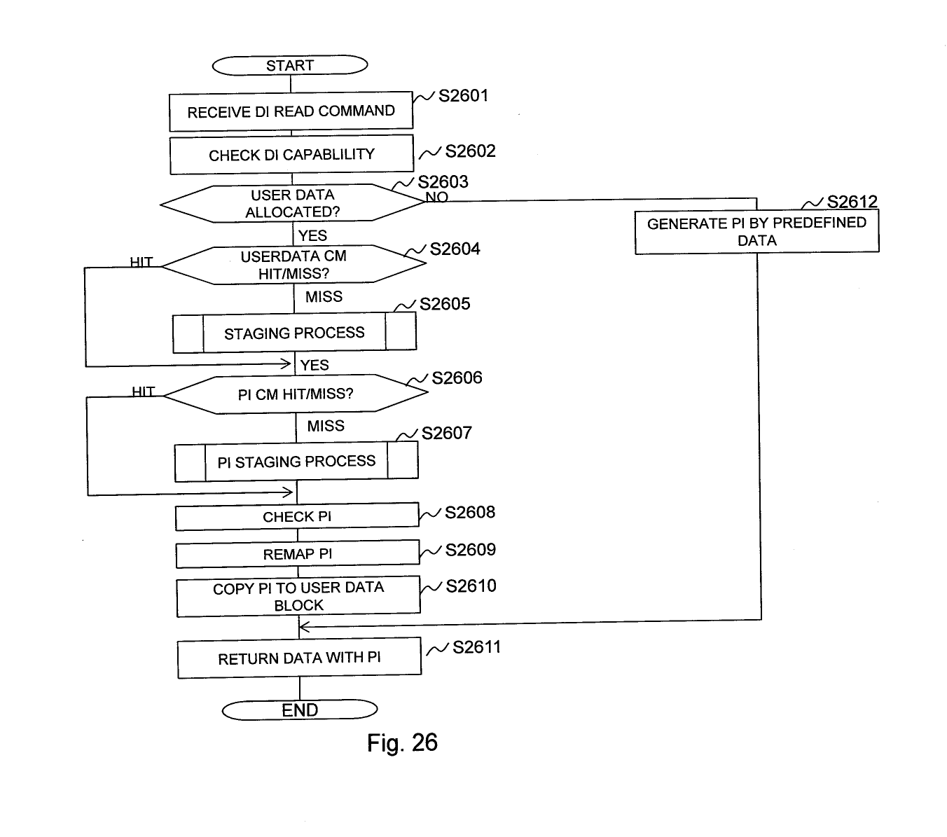

FIG. 26 is a flow diagram illustrating an example of a read I/O process according to the third embodiment. For simplify, normal read command case processes or error case processes are omitted in this figure. The storage system receives a DI read command (S2601), check the DI capability (S2602), and checks whether the userdata is allocated (S2603). If no, the storage system generates PI by predefined data (S2612) and returns data with PI (S2611). It is possible that the chunk for userdata is released after allocation using, for example, 0 reclaim technology. In such case, the chunk for PI may be allocated already if the userdata is not allocated, so that the storage system also checks whether PI block is allocated or not, and returns stored PI if allocated. If yes, the storage system checks for userdata CM hit/miss in S2604. If hit, the process goes to S2606. If miss, the storage system performs userdata staging process to CM (S2605) and the process goes to S2606. In S2606, the storage system checks for PI CM hit/miss (whether blocks for PI exist on CM). If hit, the process goes to S2608. If miss, the storage system performs PI staging process to CM (S2607) and the process goes to S2608. In S2608, the storage system checks PI. The storage system remaps PI (S2609) and copies PI from PI block to userdata block on CM (S2610). It is possible that PI combination to userdata is done on transfer buffer of I/O controller from userdata block and PI block on CM. The storage system returns data with PI (S2611) and the procedure ends.

Fourth Embodiment

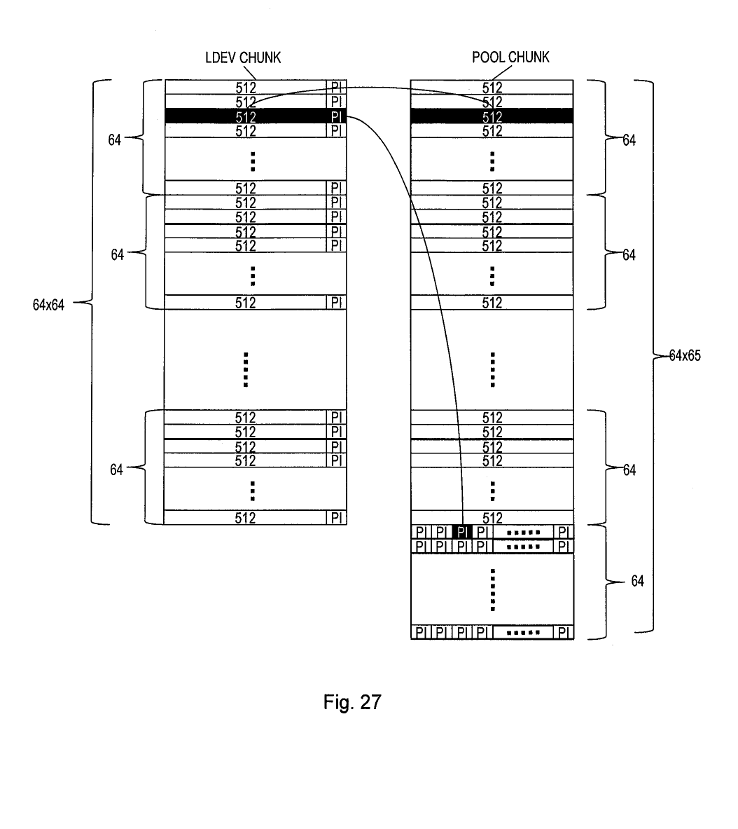

FIG. 27 is a diagram illustrating LDEV block to pool block mapping according to the fourth embodiment. The main difference from the third embodiment (FIG. 22) is that PI blocks are allocated in the same pool chunk. LDEV chunk unit size is 64×64 blocks and pool chunk unit size is 64×65 blocks. This is the most capacity efficient ratio, but it is possible to use some other unit size. Because the userdata and PI are in the same pool chunk, allocation of PI chunk and PI block steps can be skipped. Because the userdata and PI are in the same pool chunk, mapping information from userdata block to PI block can be offset in the pool chunk.

Fifth Embodiment

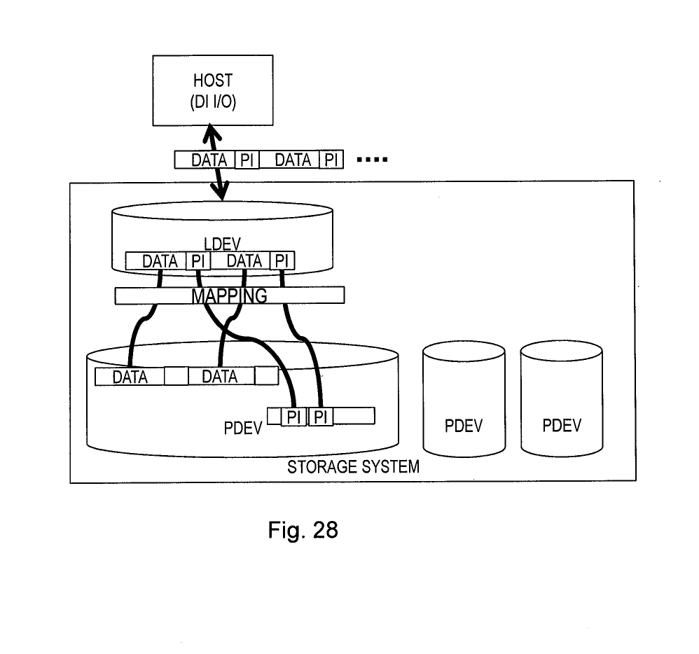

FIG. 28 is a system block diagram illustrating an outline of data integrity protection according to the fifth embodiment. The main difference from the third embodiment (FIG. 21) is that the storage pool consists of internal devices. The internal devices have PI areas. The storage system uses them to store internal PI using, for example, conventional technology. The storage system stores PI for the host server (DIF/DIX PI) in some other block separated from the userdata block. It is possible that the storage pool includes both internal devices and external devices by combining the features of the third and fifth embodiments.

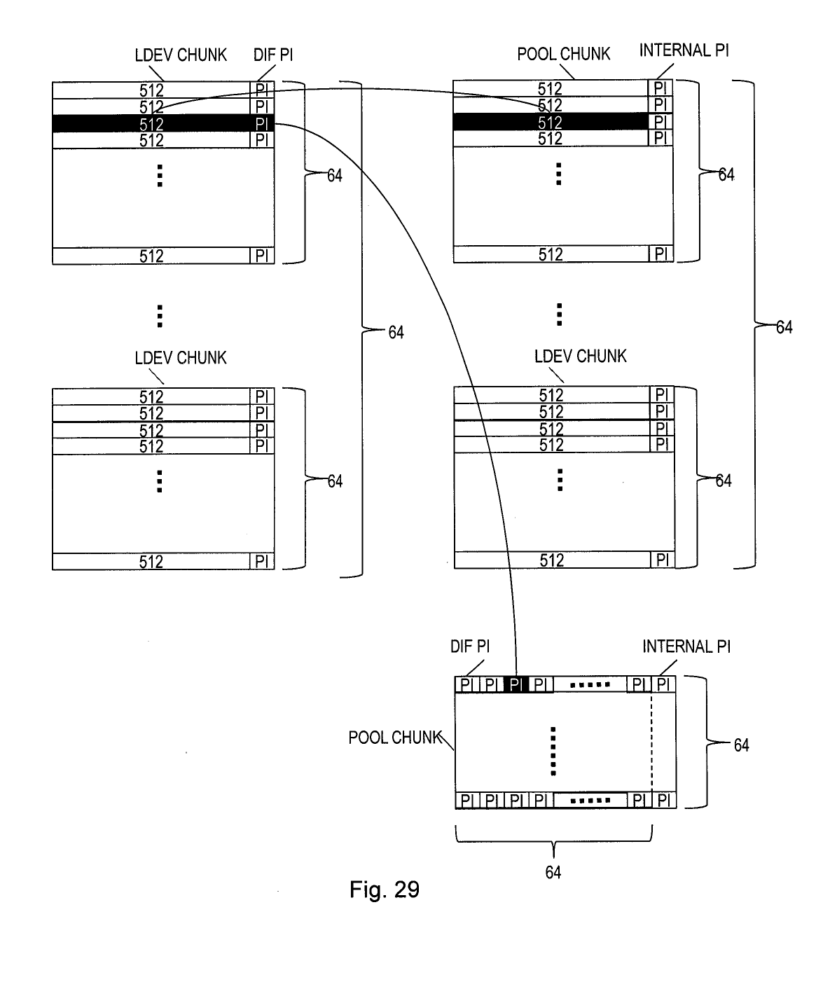

FIG. 29 is a diagram illustrating LDEV block to pool block mapping according to the fifth embodiment. The main difference from the third embodiment (FIG. 22) is that pool chunk also have PI areas beside userdata, but the storage system uses the PI areas to store internal PI to check internal integrity. In other words, end-to-end PI is stored in a different pool chunk and DKC (disk controller) internal PI is stored with userdata. It is possible that end-to-end PI can be stored in the same pool chunk as userdata in a manner similar to the fourth embodiment.

Sixth Embodiment

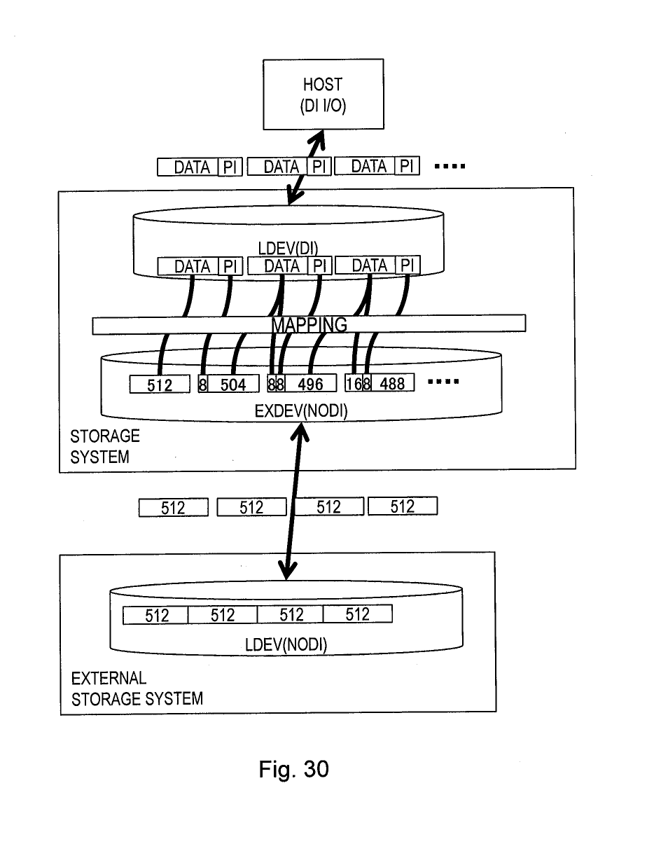

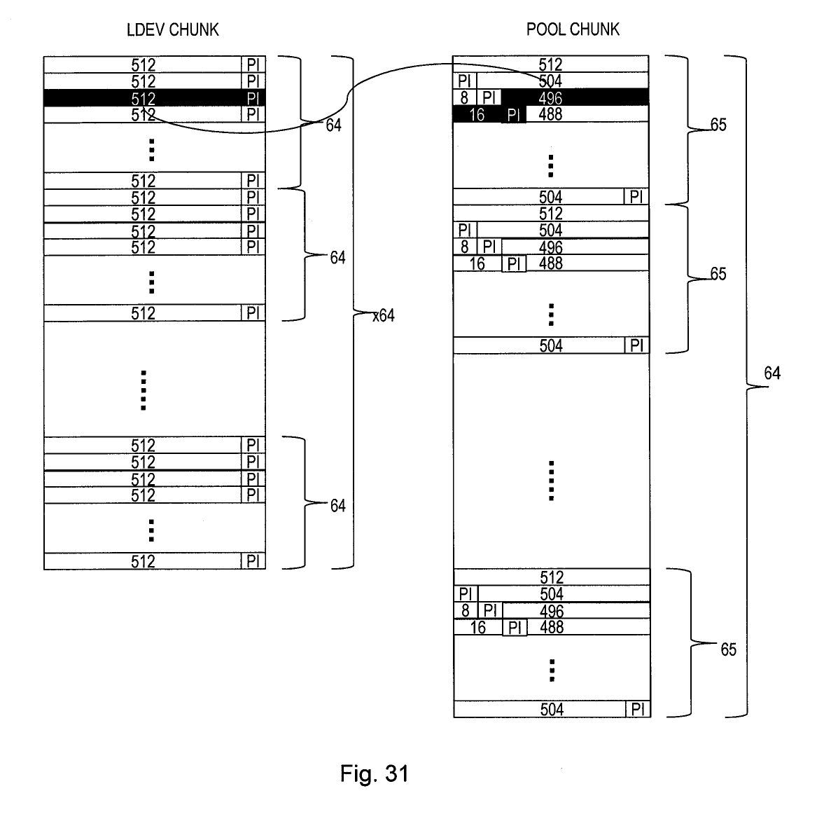

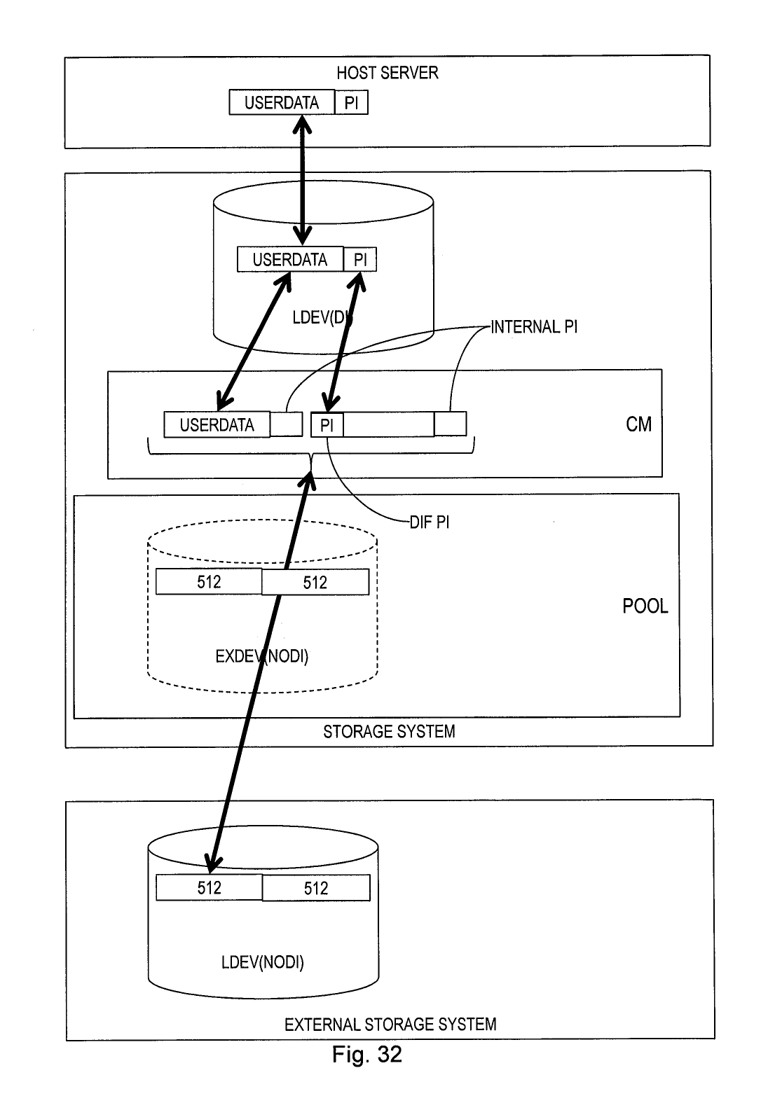

FIG. 30 is a system block diagram illustrating an outline of data integrity protection according to the sixth embodiment. FIG. 31 is a diagram illustrating LDEV block to pool block mapping according to the sixth embodiment. FIG. 32 is a diagram illustrating an outline of placing userdata and PI according to the sixth embodiment. The main difference from the third embodiment (FIGS. 21-23) is that the PI for host server is beside the userdata by storing the PI in the userdata area of next block. For example, the LDEV chunk unit size is 64×64 blocks and the pool chunk unit size is 64×65 blocks. It is possible that the storage pool includes both internal devices and external devices.

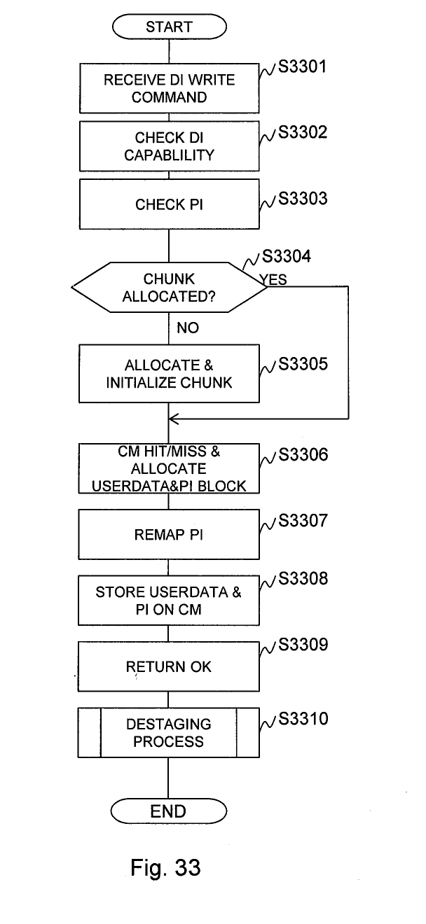

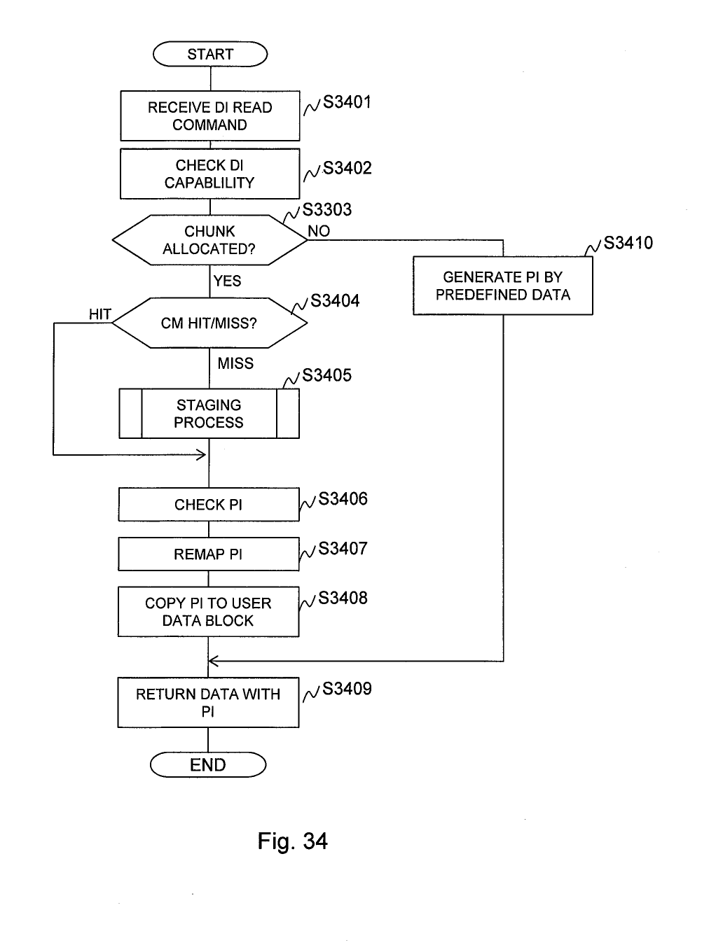

FIG. 33 is a flow diagram illustrating an example of a write I/O process according to the sixth embodiment. FIG. 34 is a flow diagram illustrating an example of a read I/O process according to the sixth embodiment. The main difference from the third embodiment (FIGS. 25 and 26) is that, in calculating pool blocks address from LDEV blocks address as requested by the host I/O command, the storage system uses information such as the mapping shown in FIG. 31 for the sixth embodiment. The number of pool blocks is larger than the number of LDEV blocks.

In FIG. 33, steps S3301-S3303 are similar to steps S2501-S2503 of FIG. 25. In S3304, the storage system checks whether a chunk is allocated or not. If yes, the process goes to S3306. If no, the storage system allocates and initializes a chunk in S3305. In S3306, the storage system checks for CM hit/miss and allocates userdata and PI block. The storage system remaps PI (S3307), stores userdata and PI on CM (S3308), returns OK (S3309), and performs destaging process (S3310).

In FIG. 34, steps S3401 and S3402 are similar to steps S2601 and S2602 of FIG. 26. In S3303, the storage system checks whether a chunk is allocated. If no, the storage system generates PI by predefined data (S3410) and returns data with PI (S3409). If yes, the storage system checks for CM hit/miss in S3404. If hit, the process goes to S3406. If miss, the storage system performs a staging process in S3405. In S3406, the storage system checks PI. The storage system remaps PI (S3407), copies PI to userdata block (S3408), and returns data with PI (S3409), and the procedure ends.

Seventh Embodiment

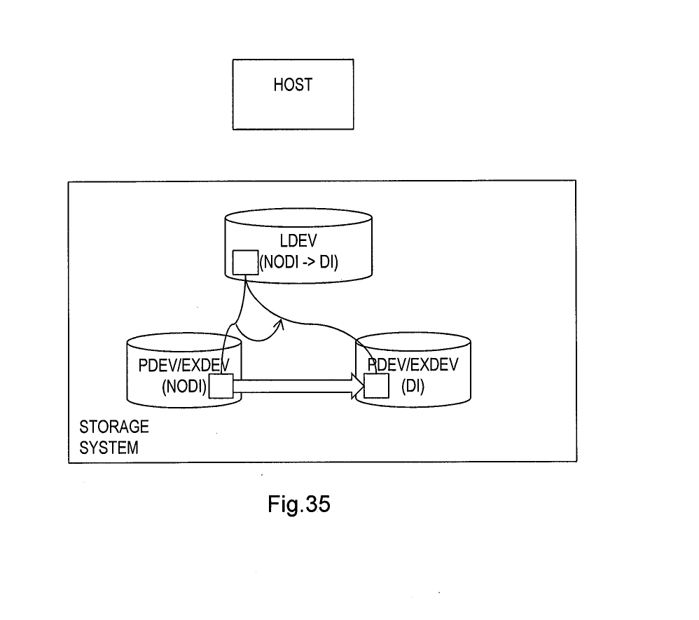

FIG. 35 is a system block diagram illustrating an outline of data integrity protection according to the seventh embodiment. In this embodiment, the DI capability of LDEV can be changed.

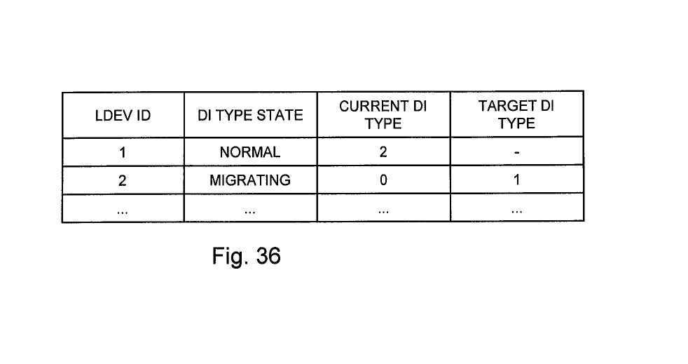

FIG. 36 shows an example of information of DI TYPE STATE. DI TYPE STATE is state of migrating LDEV DI type. The NORMAL state means the DI type is stable. The MIGRATING state means the DI type is migrating. During migration, LDEV has current (old) DI type and migration target DI type.

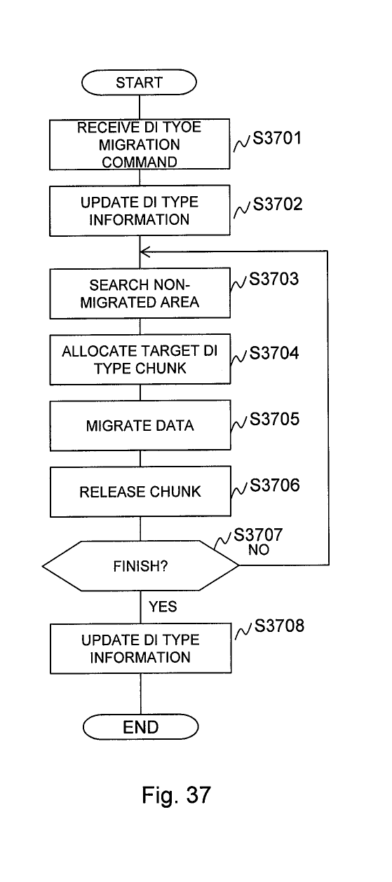

FIG. 37 is a flow diagram illustrating an example of DI type migration process according to the seventh embodiment. In S3701, the storage system receives a DI type migration request from the management server or host server. The request includes LDEV ID and migration target DI type. In S3702, the storage system updates the DI TYPE STATE and target DI type. In S3703-S3707, the storage system searches old DI type chunk and migrates data to target DI type chunk. This involves searching in-migrated area (S3703), allocating target DI type chunk (S3704), migrating chunk data (copy data from source chunk to target chunk) (S3705), releasing migrated source chunk (S3706), and checking whether it is finished (S3707). If no, the process returns to S3703. If yes, the storage system updates the DI TYPE STATE to normal, current DI type, and target DI type in S3708, and the procedure ends. It is possible that there is no userdata migration but just updating PI. It is possible that the storage system migrates between capable and incapable.

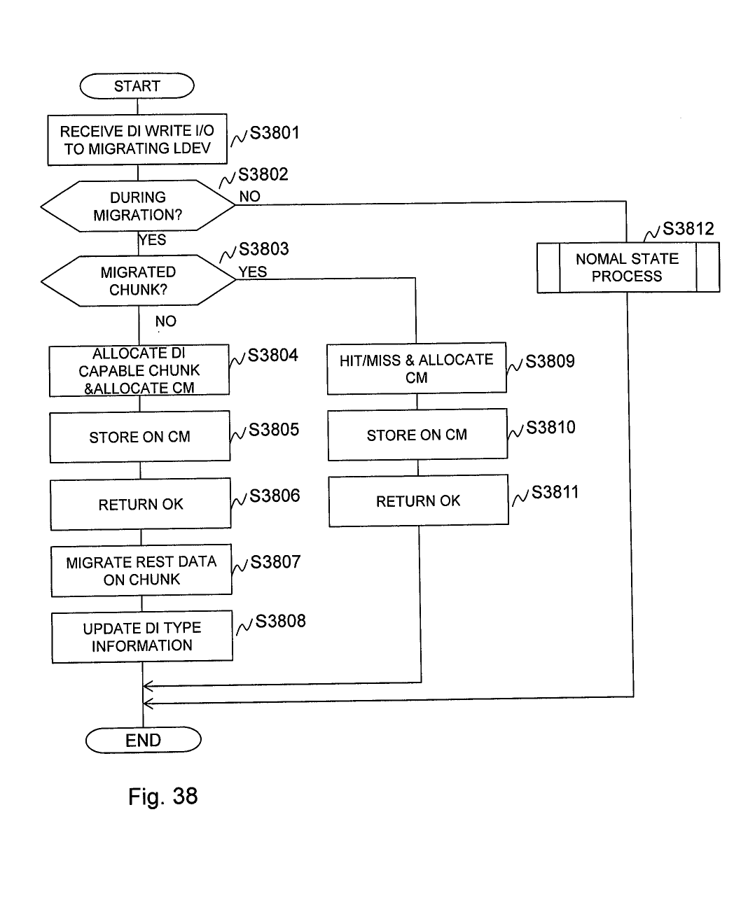

FIG. 38 is a flow diagram illustrating an example of DI write I/O process during DI type migration according to the seventh embodiment. The storage system receives a DI write I/O to migration LDEV in S3801, and checks the requested address data that have already migrated to determine whether it has been migrated in S3802. If yes, the storage system checks for hit/miss and allocates CM in S3809, stores on CM in S3810, and returns OK in S3811, and the procedure ends. If no, the storage system allocates migration target DI type (DI capable) chunk in S3803, stores on CM in S3804, and returns OK in S3805. In S3806 and S3707, the storage system migrates the rest of the data in chunk (S3806) after write I/O response to the host server and updated DI type information (S3807). It is possible that, during migration, the storage system returns error to DI I/O command. It is possible that, during migration and if the requested address data is not migrated yet, the storage system returns error to DI I/O command. It is possible that, during migration and if the requested address data is not migrated yet, the storage system generates PI of target DI type and returns it to DI read I/O command.

Eighth Embodiment

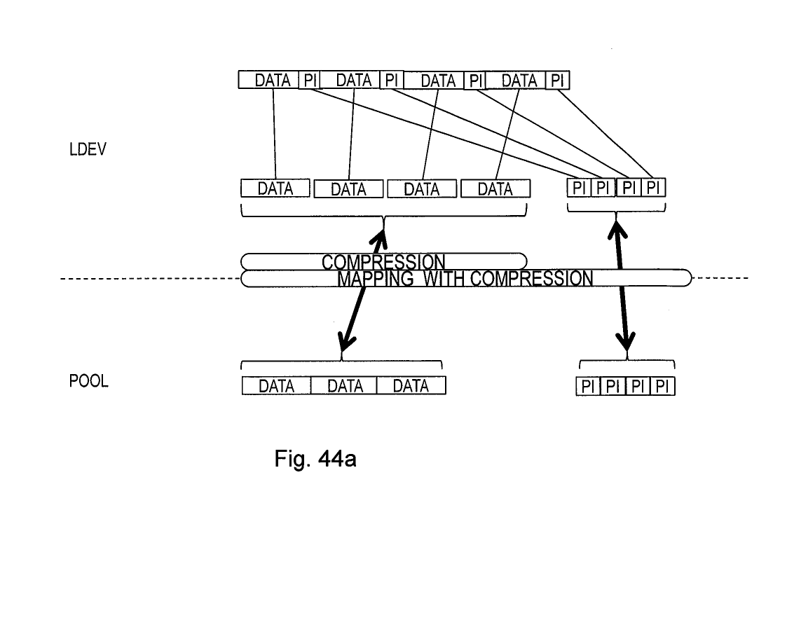

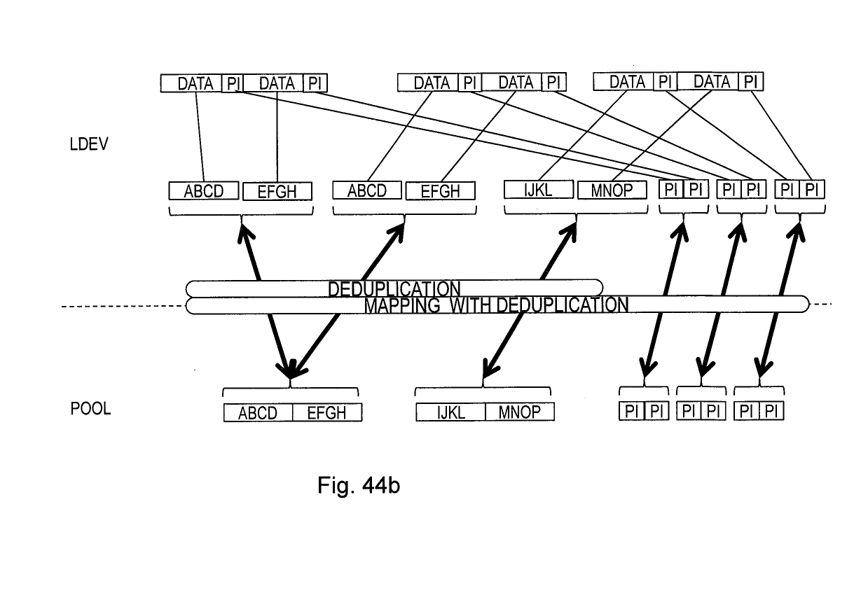

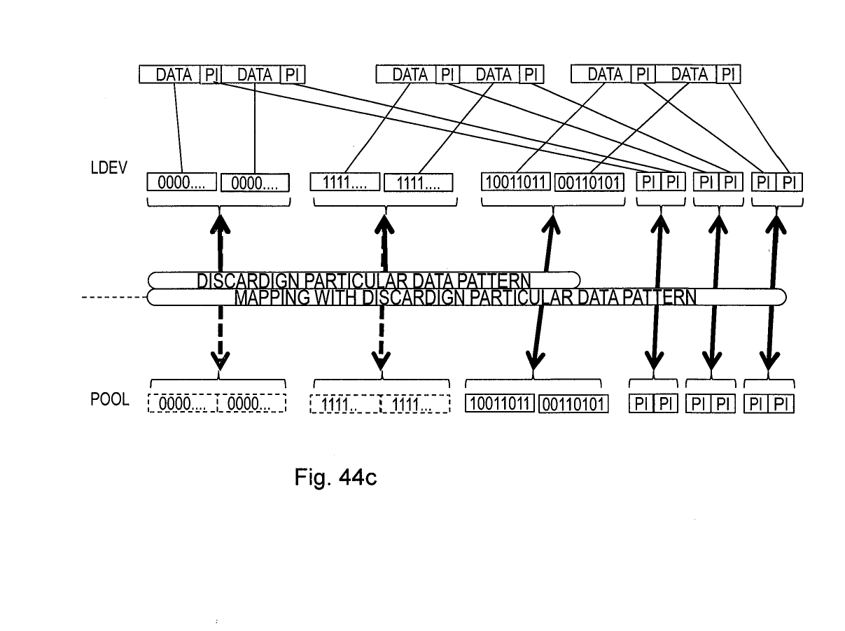

FIG. 44 shows diagrams illustrating LDEV block and pool block mapping according to the eighth embodiment. The main difference from the third embodiment (FIG. 22) is that the userdata blocks in the LDEV layer are reduced and mapped to the pool layer by using data reduction technologies, but each PI in the LDEV layer is mapped same number of PI in the pool layer. This mapping can keep information (PI) added from host servers. It is possible that only some part of PI such as APP are stored to keep information by OS/application. It is possible that the userdata blocks in the pool have PI for internal data protection. It is possible that the data reduction technologies are used and combined with each other.

FIG. 44a shows an example of data mapping with compression technology. The userdata blocks in the LDEV layer are compressed to less or equal number of the blocks in the pool layer. It is possible that the userdata blocks in the LDEV layer that have no or less reduction effectiveness are mapped same number of the userdata blocks in the pool.

FIG. 44b shows an example of data mapping with the deduplication technology. The userdata blocks in the LDEV layer which have same data pattern are mapped to one userdata block in the pool layer. The userdata may be compared and mapped in units of plural blocks.

FIG. 44c shows an example of the data mapping with the discarding particular data pattern. The userdata blocks in the LDEV layer which have the particular data pattern such as all 0, all 1, 1010 . . . or 01010 . . . are mapped to no userdata block in the pool layer and the mapping keeps the information that indicates the data pattern. The userdata may be compared and mapped in units of plural blocks. It is possible that there are the particular data pattern userdata blocks in the pool and mapped to them.

Ninth Embodiment

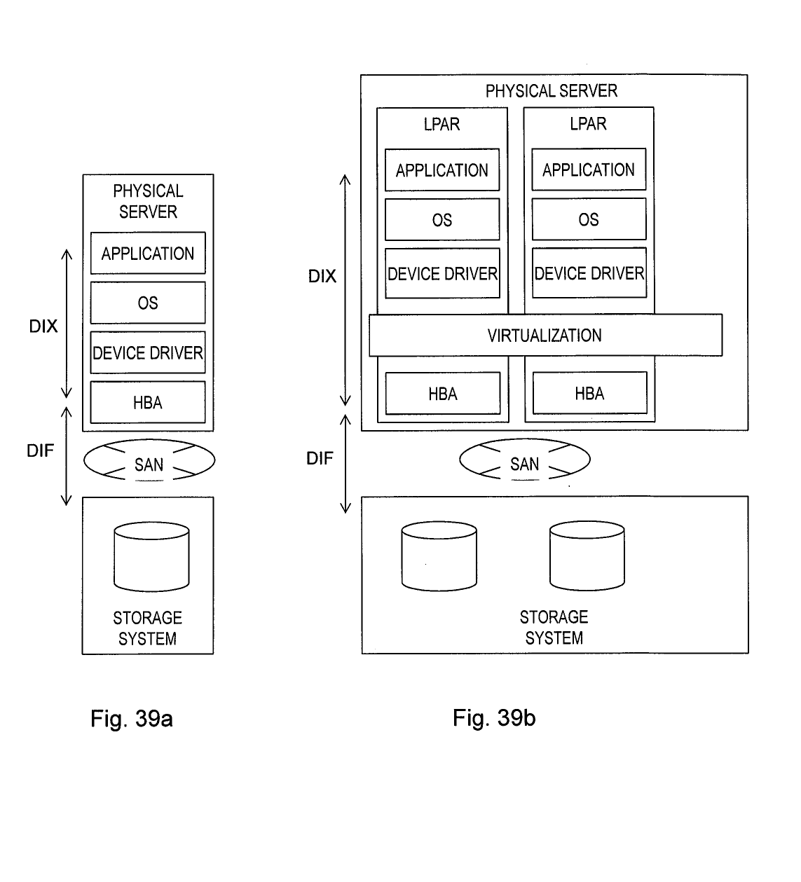

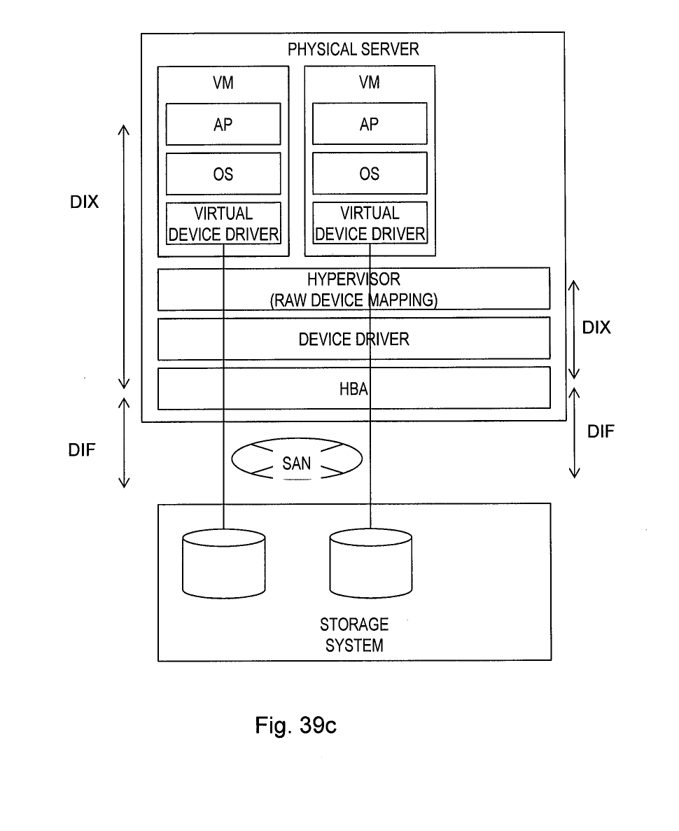

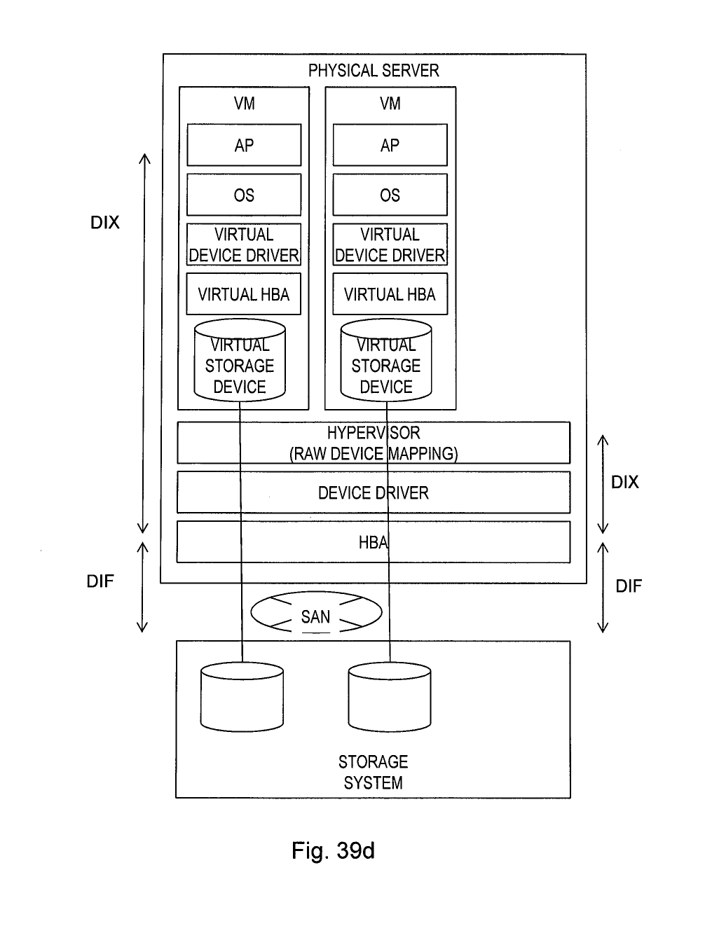

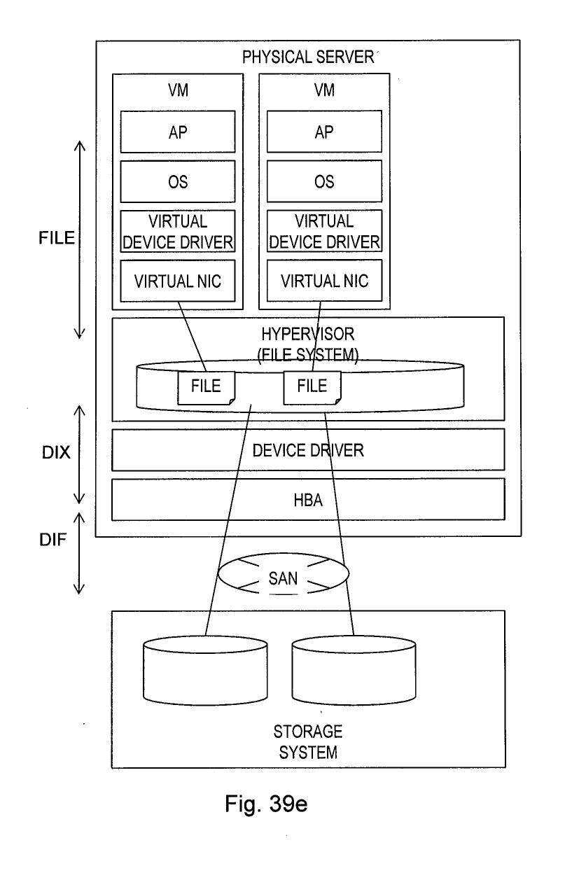

The ninth embodiment is directed to variations of logical configuration in the physical host server. These variations can be used in all former embodiments. FIG. 39 shows variations of stacks on the host server according to the ninth embodiment. There are some variations of the host server configuration. This invention can be used also in the virtual server environment. DIX I/O can be used AP/OS/hypervisor.

FIG. 39a shows a physical server case. FIG. 39b shows an example of LPAR (Logical PARtitioned) virtual server. FIG. 39c shows a virtual server hypervisor which provides storage as DAS to virtual machine. FIG. 39d shows an example of a virtual server, where a hypervisor provides raw device mapping to virtual machine. FIG. 39e shows an example of a virtual server, where a hypervisor provides file system to virtual machine.

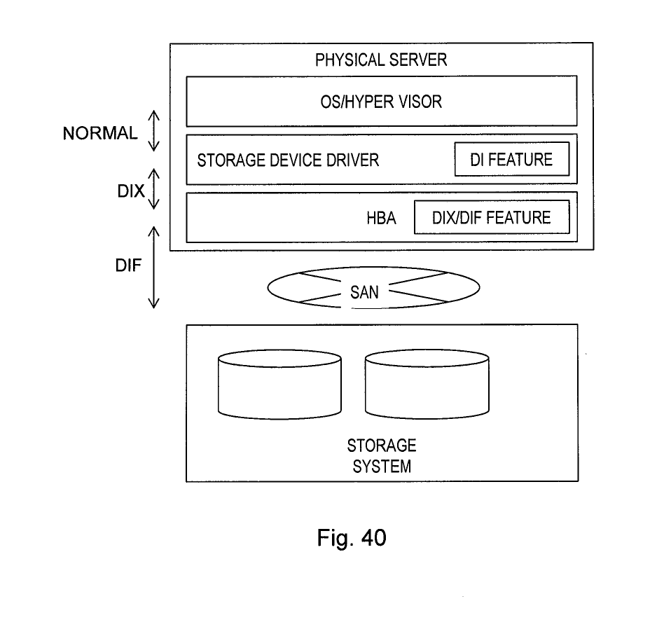

FIG. 40 is a system block diagram illustrating an outline of data integrity protection according to the ninth embodiment. It shows NORMAL, DIX, and DIF I/O.

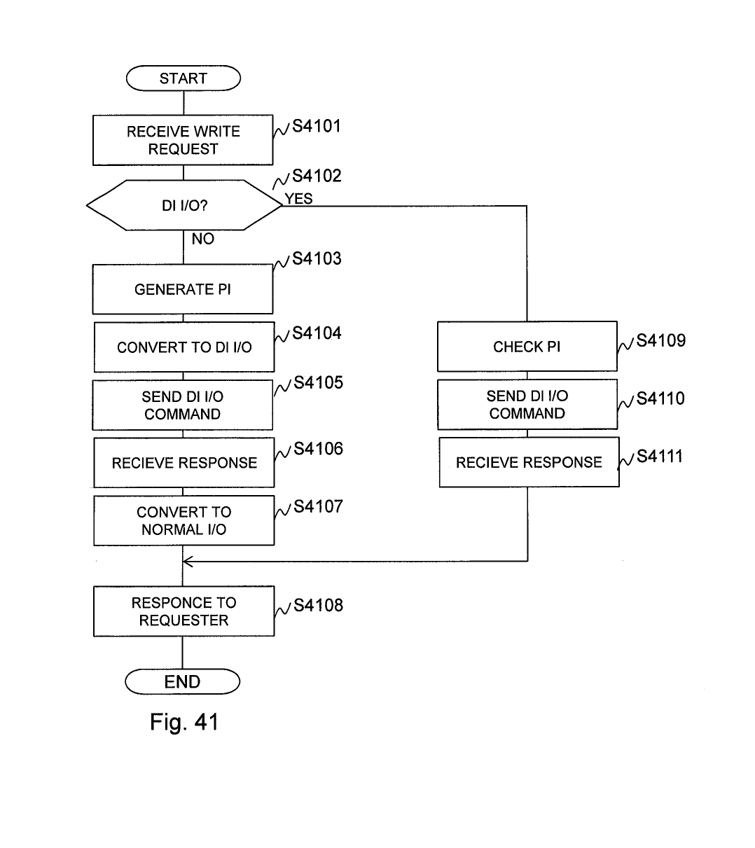

FIG. 41 is a flow diagram illustrating an example of a write I/O process according to the ninth embodiment. The storage system receives a write request in S4101 and determines whether it is a DI I/O or not in S4102. In yes, the storage system checks the PI in S4109, sends a DI I/O command in S4110, receives a response in S4111, and sends a response to the requester in S4108, and the procedure ends. If no, the storage system generates the PI in S4103, converts the request to a DI I/O in S4104, sends a DI I/O command in S4105, receives a response in S4106, converts it to a normal I/O in S4107, and sends a response to the requester in S4108, and the procedure ends.

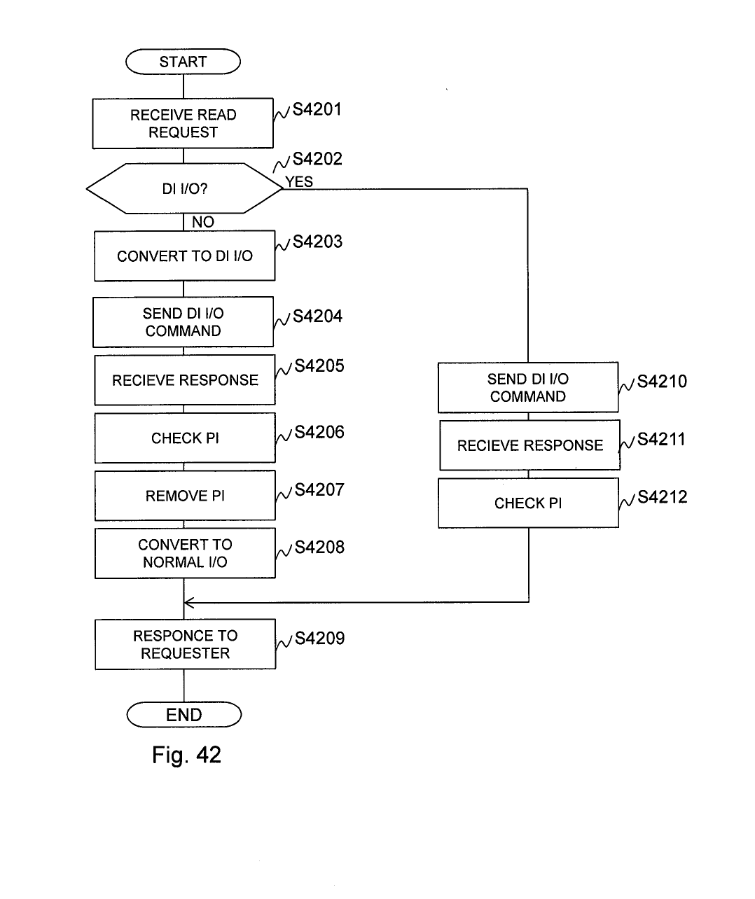

FIG. 42 is a flow diagram illustrating an example of a read I/O according to the ninth embodiment. The storage system receives a read request in S4201 and determines whether it is a DI I/O or not in S4202. If yes, the storage system sends the DI I/O command in S4210, receives a response in S4211, checks the PI in S4212, and sends a response to the requester in S4209, and the procedure ends. If no, the storage system converts the request to a DI I/O in S4203, sends a DI I/O command in S4204, receives a response in S4205, checks the PI in S4206, removes the PI in S4207, converts it to a normal I/O in S4208, and sends a response to the requester in S4209, and the procedure ends.

In this embodiment, the upper layer such as OS/hypervisor does not use DIX I/O, while the storage device driver uses DIX. The storage device driver converts normal write I/O to DI I/O and sends it to HBA. The storage device driver converts DI read I/O return to normal read I/O to OS/Hypervisor.

Of course, the system configuration illustrated in FIG. 2 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for protecting data integrity stored in storage systems. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a plurality of storage devices; and
a controller being operable to manage a plurality of logical volumes and an attribute of each of the plurality of logical volumes, the plurality of logical volumes including a first logical volume which is mapped to at least a portion of the plurality of storage devices and a second logical volume which is mapped to another storage system;
wherein the attribute of the second logical volume indicates whether or not said another storage system can support to store data including protection information added by a server; and
wherein the controller is operable to send in reply the data including the protection information, in accordance with a read request from the server, by managing the protection information and the attribute of the second logical volume.

2. The storage system according to claim 1,
wherein the controller is configured to store the data including the protection information in the first logical volume if the attribute of the second logical volume indicates that said another storage system cannot support to store the data including the protection information.

3. The storage system according to claim 1,
wherein the controller is configured to store the data including the protection information in the second logical volume if the attribute of the second logical volume indicates that said another storage system can support to store the data including the protection information.

4. The storage system according to claim 1, further comprising:
a data integrity capable storage pool and a data integrity incapable storage pool;
wherein the controller is configured to perform thin provisioning allocation, from the data integrity capable storage pool or the data integrity incapable storage pool, based on the attributes of the logical volumes; and
wherein the data integrity capable storage pool is used in the thin provisioning allocation for storing the data including the protection information, and the data integrity incapable storage pool is not used in the thin provisioning allocation for storing the data with the protection information.

5. The storage system according to claim 1,
wherein the controller is configured to use said another storage system to store the protection information, if the attribute of the second logical volume indicates that said another storage system cannot support to store the data including the protection information.

6. The storage system according to claim 1,
wherein the controller is configured to store the protection information in a logical volume which is separate from another logical volume for storing a remaining portion of the data without the protection information; and
wherein the controller is configured to combine the separately stored remaining portion of the data and protection information, in order to send in reply the data including the protection information, in accordance with the read request from the server.

7. The storage system according to claim 1,
wherein, for a plurality of data each including a protection information added by the server, the controller is operable to reconfigure a larger size storage pool chunk in a storage pool to be larger in size than a chunk for storing only a remaining portion of the data without the protection information added by the server, in order to store both the protection information and the remaining portion of the data without the protection information in the same storage pool chunk.

8. A system comprising:
a plurality of storage systems including a first storage system and a second storage system;
wherein the first storage system includes a plurality of storage devices and a controller, the controller being operable to manage a plurality of logical volumes and an attribute of each of the plurality of logical volumes, the plurality of logical volumes including a first logical volume which is mapped to at least a portion of the plurality of storage devices and a second logical volume which is mapped to the second storage system;
wherein the attribute of the second logical volume indicates whether or not the second storage system can support to store data including protection information added by a server; and
wherein the controller is operable to send in reply the data including the protection information, in accordance with a read request from the server, by managing the protection information and the attribute of the second logical volume.

9. The system according to claim 8,
wherein the controller is configured to store the data including the protection information in the first logical volume if the attribute of the second logical volume indicates that the second storage system cannot support to store the data including the protection information.

10. The system according to claim 8,
wherein the controller is configured to store the data including the protection information in the second logical volume if the attribute of the second logical volume indicates that the second storage system can support to store the data including the protection information.

11. The system according to claim 8,
wherein the first storage system includes a data integrity capable storage pool and a data integrity incapable storage pool;
wherein the controller is configured to perform thin provisioning allocation, from the data integrity capable storage pool or the data integrity incapable storage pool, based on the attributes of the logical volumes; and
wherein the data integrity capable storage pool is used in the thin provisioning allocation for storing the data including the protection information, and the data integrity incapable storage pool is not used in the thin provisioning allocation for storing the data with the protection information.

12. The system according to claim 8,
wherein the controller is configured to use the second storage system to store the protection information, if the attribute of the second logical volume indicates that the second storage system cannot support to store the data including the protection information.

13. The system according to claim 8,
wherein the controller is configured to store the protection information in a logical volume which is separate from another logical volume for storing a remaining portion of the data without the protection information; and
wherein the controller is configured to combine the separately stored remaining portion of the data and protection information, in order to send in reply the data including the protection information, in accordance with the read request from the server.

14. The system according to claim 8,
wherein, for a plurality of data each including a protection information added by the server, the controller is operable to reconfigure a larger size storage pool chunk in a storage pool of the first storage system to be larger in size than a chunk for storing only a remaining portion of the data without the protection information added by the server, in order to store both the protection information and the remaining portion of the data without the protection information in the same storage pool chunk.

15. A computer-readable storage medium storing a plurality of instructions for controlling a data processor to manage a storage system which includes a plurality of storage devices, the plurality of instructions comprising:
instructions that cause the data processor to manage a plurality of logical volumes and an attribute of each of the plurality of logical volumes, the plurality of logical volumes including a first logical volume which is mapped to at least a portion of the plurality of storage devices and a second logical volume which is mapped to another storage system, wherein the attribute of the second logical volume indicates whether or not said another storage system can support to store data including protection information added by a server; and
instructions that cause the data processor to send in reply the data including the protection information, in accordance with a read request from the server, by managing the protection information and the attribute of the second logical volume.

16. The computer-readable storage medium according to claim 15,
wherein the controller is configured to store the data including the protection information in the first logical volume if the attribute of the second logical volume indicates that said another storage system cannot support to store the data including the protection information.

17. The computer-readable storage medium according to claim 15,
wherein the controller is configured to store the data including the protection information in the second logical volume if the attribute of the second logical volume indicates that said another storage system can support to store the data including the protection information.

18. The computer-readable storage medium according to claim 15, wherein the plurality of instructions further comprise:
instructions that cause the data processor to perform thin provisioning allocation, from a data integrity capable storage pool or a data integrity incapable storage pool in the storage system, based on the attributes of the logical volumes; and
wherein the data integrity capable storage pool is used in the thin provisioning allocation for storing the data including the protection information, and the data integrity incapable storage pool is not used in the thin provisioning allocation for storing the data with the protection information.

19. The computer-readable storage medium according to claim 15, wherein the plurality of instructions further comprise:
instructions that cause the data processor to use said another storage system to store the protection information, if the attribute of the second logical volume indicates that said another storage system cannot support to store the data including the protection information.

20. The computer-readable storage medium according to claim 15, wherein the plurality of instructions further comprise:
instructions that cause the data processor to store the protection information in a logical volume which is separate from another logical volume for storing a remaining portion of the data without the protection information; and
instructions that cause the data processor to combine the separately stored remaining portion of the data and protection information, in order to send in reply the data including the protection information, in accordance with the read request from the server.
